(19) United States
(12) Patent Application Publication
(10) Pub. No.: US 2025/0346141 A1
(43) Pub. Date: Nov. 13, 2025

(54) Systems and Methods for Electric Vehicle Charging

(71) Applicant: Daimler Truck AG, Leinfelden-Echterdingen (DE)

(72) Inventors: Adabala Venkata Satya Sriharsha, Bhimanapalli (IN); Ashish Bansod, Portland, OR (US); Tibinmon Pulimoottil Monichan, Kottayam (IN)

(21) Appl. No.: 18/991,271

(22) Filed: Dec. 20, 2024

(30) Foreign Application Priority Data
May 8, 2024 (IN) 202411036519

(51) Int. Cl. B60L 53/62; B60L 53/10; B60L 53/16; B60L 53/20

(52) U.S. Cl. CPC B60L 53/62; B60L 53/11; B60L 53/16; B60L 53/20

(57) ABSTRACT

A charging system for an electric vehicle includes a charge port configured to receive electrical power, a battery contactor that is connected to terminals of a power storage device of the electric vehicle, a fast charge contactor connected in a Direct Current path between the charge port and the battery contactor, and an on-board charger connected in an Alternating Current path between the charge port and the battery contactor. The charging system further includes a PathSet Contactor that is configured to control the electrical power from the charge port to the battery contactor, and a controller that is configured to control switching of at least the PathSet Contactor and the fast charge contactor to control charging of the power storage device. A method of charging an electric vehicle using the charging system is also disclosed.

### RELATED APPLICATIONS

This application claims priority to Indian patent application Ser. No. 202411036519 filed May 8, 2024, entitled Charging Systems for an Electric Vehicle and Method Thereof, which is incorporated by reference herein in its entirety.

### TECHNICAL FIELD

The present disclosure relates to the field of electric vehicles. In particular, the present disclosure pertains to methods and systems for electric vehicle charging.

### BACKGROUND

Today, there is a wide range of vehicles employing power storage devices, such battery packs, to help power them. These vehicles are generally known as electric vehicles, which encompass pure electric ones that solely rely on the power storage devices, hybrid electric vehicles (HEVs) capable of running on either fuel-based engines or the power storage devices, and fuel cell vehicles or hybrid fuel cell vehicles, among others.

Electric vehicles offer an eco-friendly alternative to traditional fuel-powered vehicles, emitting less pollution. Despite their increasing popularity, one hurdle to widespread adoption of the electric vehicles is the disparity in charging techniques compared to refueling methods for the fuel-powered vehicles. Electric vehicles are generally charged through direct wired connections from fixed charging stations to ports or adapters installed on the vehicle. Electric vehicles can be charged using any of an Alternating Current (AC) power supply or a Direct Current (DC) power source. Some electric vehicles employ converters to convert electrical power from AC to DC prior to charging the power storage device mounted on the electric vehicle. This is the most common charging method for electric vehicles today, since most electric vehicles and most charging stations use AC power. Unlike AC charging stations, DC charging stations have a converter inside the charging station itself and can directly provide DC power to the power storage device (e.g., with AC to DC conversion). Such DC charging stations eliminate the requirement of converters to be installed in electric vehicles. Additionally, DC charging stations are capable of rapidly charging power storage devices installed in electric vehicles.

Most electric vehicles require separate ports to assist charging by AC charging stations and DC charging stations, since the supply of AC power from the AC charging stations to the power storage device installed in the vehicle is performed in a different manner as compared to the supply of DC power from the DC charging stations.

Thus, there is a need in the field for a simple, reliable, and cost-effective solution to overcome the drawbacks and limitations of conventional charging topologies for electric vehicles, while enhancing the safety and reliability of the charging topologies used in these vehicles.

### SUMMARY

The present disclosure relates to methods and systems for charging a power storage device, such as a battery pack, installed in an electric vehicle. In some embodiments, the charging system comprises a charge port connected to an electric vehicle supply equipment (EVSE) and configured to receive electrical power from the EVSE, a battery contactor connected to terminals of a power storage device of the electric vehicle, a fast charge contactor (FCC) connected in a Direct Current (DC) path between the charge port and the battery contactor to enable DC charging of the power storage device, and an on-board charger connected in an Alternating Current (AC) path between the charge port and the battery contactor, and configured to enable AC charging of the power storage device. The system also includes a PathSet contactor (PSC) configured to control the electrical power from the charge port to the battery contactor and to switch between the DC charging and the AC charging of the power storage device. The system further includes a controller configured to control switching of at least the PSC and the FCC to control charging of the power storage device.

In some embodiments, the PSC is configured to control the electrical power between the DC path and the AC path based on detection of an anomaly in the FCC.

In some embodiments, the PSC is configured to control supplying electrical power, selecting between either the DC path or the AC path based on detection that one or more contacts of the fast charge contactor are in a welded state.

In some embodiments, the PSC includes a plurality of switches positioned in the DC path between the charge port and the FCC. The PSC may be configured to switch between unidirectional paths generated by a plurality of diodes to selectively control the supply of the electrical power to the power storage device in the DC path and to control the supply of electric energy of the power storage device to a secondary power storage device. The controller may be configured to open the PSC when the anomaly in the FCC is detected and the charge port is receiving AC power.

In some embodiments, the controller is configured to close the PSC when an operating voltage of the power storage device is higher than a peak voltage in the AC path and to open the PathSet Contactor when the operating voltage of the power storage device is lower than or equal to the peak voltage in the AC path.

In some embodiments, the PSC includes a 4Quadrant (4Q) switch positioned in the DC path between the charge port and the FCC to selectively control supplying the electrical power to the power storage device in the DC path and to control supplying the electric energy of the power storage device to a secondary power storage device. The controller is configured to operate the 4Q switch to an open state when the anomaly in the FCC is detected and the charge port is receiving AC power.

In some embodiments, the PSC includes an AC/DC switch configured to switch supplying of the electrical power from the charge port between the DC path and the AC path to enable selective switching between the DC charging and the AC charging of the power storage device. In some embodiments, the system further includes a diode positioned downstream of the on-board charger in the AC path. The controller is configured to close or open the AC/DC switch depending on the type of charging (AC charging or DC charging) and the state of the diode placed (forward bias or reverse bias).

In some embodiments, the PSC includes an AC contactor positioned downstream of the on-board charger in the AC path and operating complementarily (e.g., inversely) with the FCC. The controller is configured to close the fast charge contactor to enable DC charging of the power storage device when the AC/DC switch is connected to the DC path and the diode is in reverse bias, open the fast charge contactor to enable AC charging of the power storage device when the AC/DC switch is connected to the AC path and the diode is in forward bias, and open the AC/DC switch when an anomaly is detected in the fast charge contactor or an anomaly is detected in the diode and the charge port is receiving AC power.

In some embodiments, a charging method for a power storage device of an electric vehicle includes (i) receiving electrical power at a charge port; (ii) determining whether the electrical power is Direct Current (DC) power or Alternating Current (AC) power; and (iii) controlling, by a controller, switching of at least a fast charge contactor and a PathSet contactor to enable selectively transmitting the electrical power from the charge port to a power storage device via a DC path or an AC path. The fast charge contactor is connected in a DC path between the charge port and a battery contactor. The battery contactor is connected to terminals of the power storage device of the electric vehicle. The PathSet contactor is configured to control supplying the electric power from the charge port to the battery contactor and switch between DC charging of the power storage device via the DC path and AC charging of the power storage device via the AC path.

In some embodiments, the method further includes detecting an anomaly in the fast charge contactor; and in response to detecting the anomaly in the fast charge contactor, controlling, by the controller, switching of at least the fast charge contactor and the PathSet contactor to direct the electrical power between utilizing the DC path or utilizing the AC path.

In some embodiments, the PathSet Contactor includes a plurality of switches positioned in the DC path between the charge port and the fast charge contactor. The method further includes, in response to a determination that the electrical power received at the charge port is DC power, switching one or more switches of the plurality of switches to a closed state and switching the fast charge contactor to a closed state to enable charging of the power storage device via the DC path. The method also includes, in response to a determination that the electrical power received at the charge port is AC power, switching one or more switches of the plurality of switches to an open state and switching the fast charge contactor to an open state to enable charging of the power storage device via the DC path.

In some embodiments, the method further includes determining an operating voltage of the power storage device and a peak voltage in the AC path. The method also includes, in response to (i) a determination that the electrical power received at the charge port is AC power, (ii) detection of an anomaly, and (iii) a determination that the operating voltage of the power storage device is higher than the peak voltage in the AC path: switching one or more switches of the plurality of switches to a closed state. The method further includes, in response to (i) a determination that the electrical power received at the charge port is AC power, (ii) detection of an anomaly, and (iii) a determination that the operating voltage of the power storage device is lower than or equal to the peak voltage in the AC path: switching one or more switches of the plurality of switches to an open state.

In some embodiments, the PathSet Contactor includes a 4Quadrant switch that is positioned in the DC path between the charge port and the fast charge contactor. The method further includes, in response to a determination that the electrical power received at the charge port is DC power, switching the 4Quadrant switch to a closed state and switching the fast charge contactor to a closed state to selectively control supplying the electrical power to the power storage device in the DC path. The method also includes, in response to a determination that the electrical power received at the charge port is AC power, switching the 4Quadrant switch to a closed state and switching the fast charge contactor to an open state to selectively control supplying the electrical power to the power storage device in the DC path.

In some embodiments, the method further includes, determining an operating voltage of the power storage device and a peak voltage in the AC path. The method also includes, in response to (i) a determination that the electrical power received at the charge port is AC power, (ii) detection of an anomaly, and (iii) a determination that the operating voltage of the power storage device is higher than the peak voltage in the AC path: switching the 4Quadrant switch to a closed state and switching the fast charge contactor to a closed state to selectively control supplying the electrical power to the power storage device in the DC path. The method also includes, in response to (i) a determination that the electrical power received at the charge port is AC power, (ii) detection of an anomaly, and (iii) a determination that the operating voltage of the power storage device is lower than or equal to the peak voltage in the AC path: switching the 4Quadrant switch to an open state and switching the fast charge contactor to an open state to selectively control supplying the electrical power to the power storage device in the DC path.

In some embodiments, the PathSet Contactor includes an AC/DC switch that is connected to the AC path, and the AC path includes a diode. The method further includes, in response to a determination that the electrical power received at the charge port is DC power and in response to a determination that the diode is connected in the AC path is in reverse bias, connecting the AC/DC switch to the DC path and switching the fast charge contactor to a closed state to enable DC charging of the power storage device via the DC path. The method also includes, in response to a determination that the electrical power received at the charge port is AC power and in response to a determination that the diode is connected in the AC path is in forward bias, connecting the AC/DC switch to the DC path and switching the fast charge contactor to an open state to enable AC charging of the power storage device via the AC path.

In some embodiments, the method further includes, in response to a determination that the electrical power received at the charge port is AC power and in response to detecting the anomaly in the fast charge contactor, connecting the AC/DC switch to the AC path.

In some embodiments, the PathSet Contactor includes an AC contactor positioned in the AC path and the AC contactor operates inversely with the fast charge contactor. The method further includes determining, by the controller, operating states of the fast charge contactor and the AC contactor. The method also includes, in response to a determination that the electrical power received at the charge port is DC power and in response to a determination that the AC contactor is open, switching the fast charge contactor to a closed state to enable DC charging of the power storage device. The method further includes, in response to a determination that the electrical power received at the charge port is AC power and in response to a determination that the AC contactor is closed, switching the fast charge contactor to an open state to enable AC charging of the power storage device. The method also includes, in response to a determination that the fast charge contactor is open and the AC contactor is closed, triggering, by the controller, a preconditioning event signal.

In some embodiments, the method further includes, in response to a determination that the electrical power received at the charge port is AC power and in response to detecting the anomaly in the fast charge contactor, switching one or more of the AC contactor and the fast charge contactor to prevent triggering the preconditioning event signal.

In some embodiments, the method further includes controlling, by the controller, switching of at least one of the fast charge contactor and the PathSet contactor to enable supplying electrical power stored in the power storage device to a secondary power storage device.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

For a better understanding of the aforementioned systems and methods, as well as additional systems and methods that provide charging for electric vehicles, reference should be made to the Description of Implementations below, in conjunction with the following drawings in which like reference numerals refer to corresponding parts throughout the figures.

FIG. 1 illustrates a schematic representation of a conventional charging system for a power storage device of a vehicle.

FIGS. 2A-2D illustrate various schematic representations of a charging system for a power storage device of a vehicle in accordance with an embodiment of the present disclosure.

FIG. 3 provides a flowchart depicting the methodology of the charging system in accordance with an embodiment of the present disclosure.

FIG. 4 provides a flowchart showing various processes involved in a charging method for the power storage device installed in the vehicle in accordance with an embodiment of the present disclosure.

FIGS. 5A-5E provide a flowchart showing a method of charging a power storage device installed in a vehicle in accordance with an embodiment of the present disclosure.

FIG. 6 provides a flowchart showing a method of charging a power storage device installed in a vehicle in accordance with an embodiment of the present disclosure.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosures as defined by the appended claims.

Embodiments explained herein relate to a simple, reliable, and cost-effective charging system and method for improving safety and reliability of charging topologies used in electric vehicles. The charging system and method of the present disclosure also provide multiple redundancies to ensure safe operation of the charging topologies, while allowing charging of power storage devices, such as battery banks, using both Alternating Current (AC) as well as Direct Current (DC) charging stations through a single charge port. The charging system prioritizes the safety of the power storage devices within the electric vehicle, as well as the safety of the AC and DC charging stations, and effectively detects and prevent faults or irregularities in the charging process, thereby safeguarding the power storage devices of the electric vehicle.

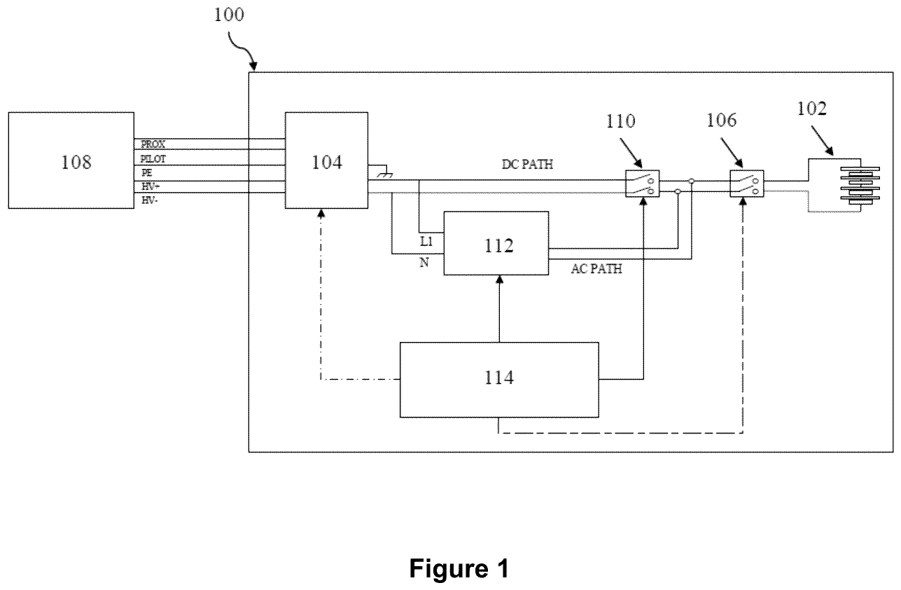

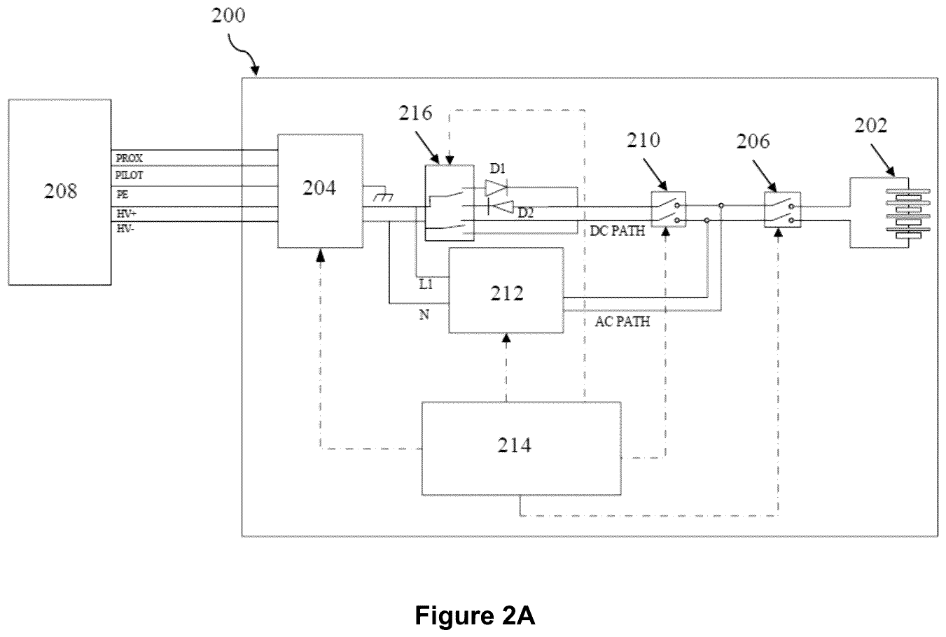

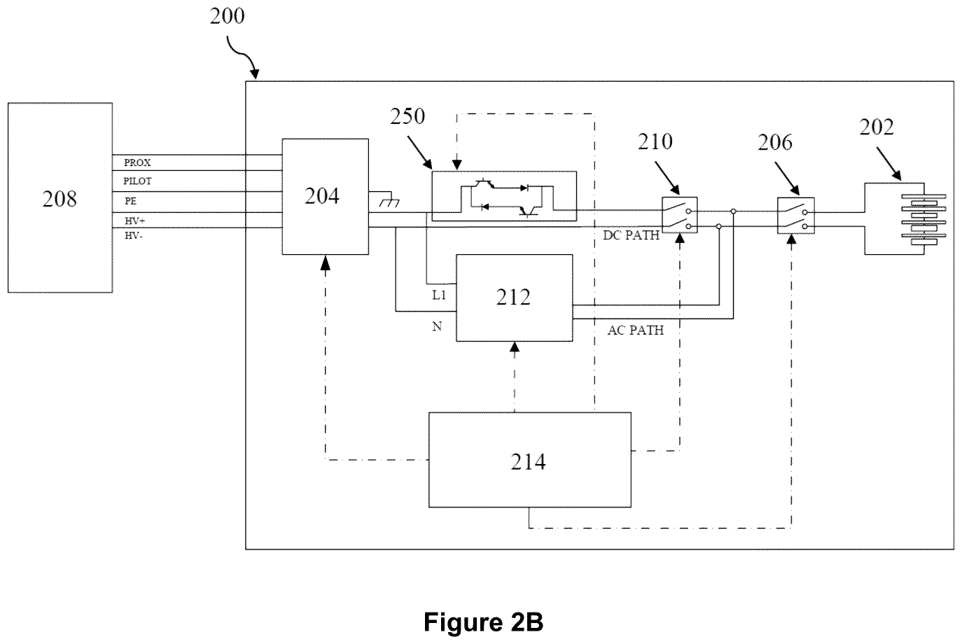

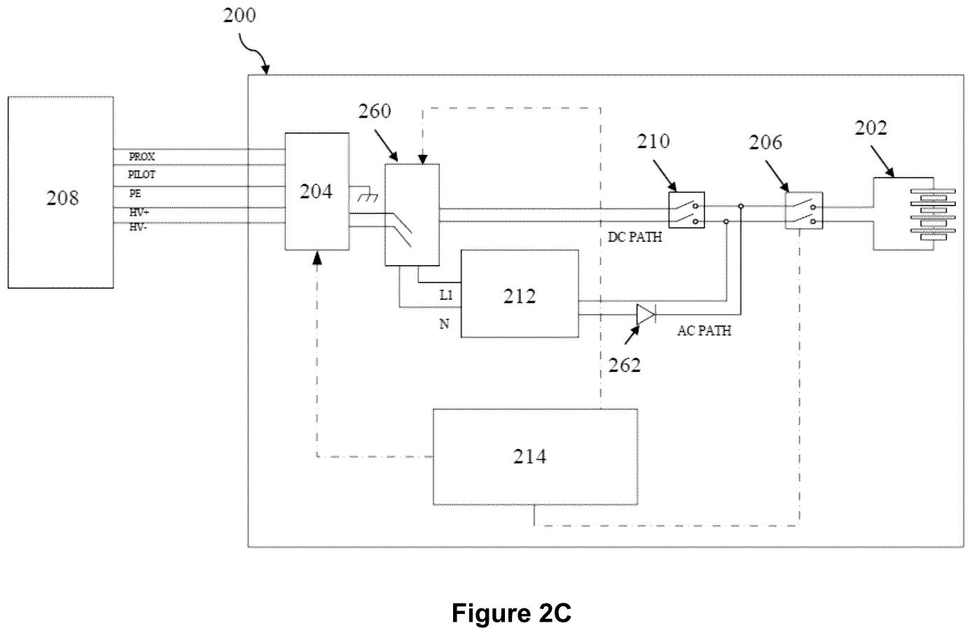

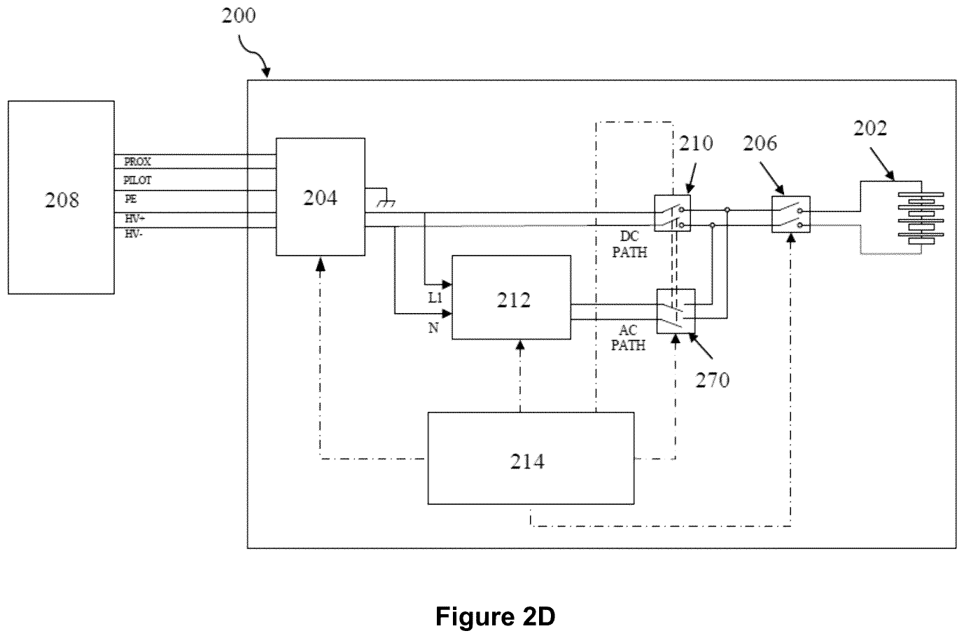

FIG. 1 illustrates a schematic representation of a conventional charging system 100 for a battery pack 102 installed in a vehicle. The system 100 is different from the claimed charging system of the present application, described below with respect to FIGS. 2A-2D. Discussion of system 100 is to highlight the shortcomings of conventional systems such as system 100 and provide contrast to the architecture of the claimed charging system of the present application, which provide significant advantages over a conventional system such as system 100.

The system 100 generally includes a charge port 104 linked to terminals of the battery pack 102 via a battery contactor 106. Typically, the battery pack 102 requires DC power for charging. The charge port 104 receives electrical power from a power supply unit 108. The charge port 104 may be in communication with a plurality of terminals, such as proximity (PROX) terminal, pilot (PILOT) terminal, Protective-Earth (PE) terminal, High Voltage Positive (HV+) terminal and High Voltage Negative (HV−) terminal of the power supply unit 108 to efficiently regulate supply of the electrical power therethrough. A DC fast charge contactor 110 is usually positioned between the charge port 104 and the battery contactor 106 to deliver electrical power directly to the battery contactor 106 when the supply received by the charge port 104 is DC power. An on-board charger 112 is provided to convert AC power supplied to the charge port 104 by the power supply unit 108 into DC and deliver it to the battery contactor 106 independently of the DC fast charge contactor 110. The system 100 also incorporates a controller 114 to manage the operations of the various contactors. Generally, the DC fast charge contactor 110 is responsible for charging the battery pack 102 with a DC power supply, while the on-board charger 112 handles charging with an AC power supply. However, if there's an anomaly associated with the DC fast charge contactor 110, such as a fault or miscommunication of its operating state to the controller 114, it may remain closed (in the ON condition) even if it's signaled to be open (in the OFF condition) to the controller 114. In such cases, if AC power is supplied to the charge port 104 by the power supply unit 108, it may be directly fed to the terminals of the battery pack 102 through the DC fast charge contactor 110, posing a risk of severe damage to the battery pack 102 due to the direct supply of AC power. These anomalies in the DC fast charge contactor 110 often result in severe damage to the battery pack 102 and any external power source connected to it.

FIG. 2A illustrates a schematic representation of a charging system 200 for a vehicle. The charging system 200 enables charging of a power storage device 202, such as one or more battery packs, installed in a vehicle, and enables discharging of the power storage device 202 by supplying discharge energy of the power storage device 202 to a secondary power storage device or to an equipment via Vehicle-to-Everything (V2X) technology.

The system 200 includes a charge port 204 that is connected to terminals of the power storage device 202 through a battery contactor 206. In some embodiments, the battery contactor 206 includes a set of relays or switches adapted to move between an open state and a closed state to selectively control (e.g., allow or block) the supply of electrical power to the terminals of the power storage device 202. In some embodiments, the charge port 204 is configured to receive the electric supply (also referred to as “electrical power”) from electric vehicle supply equipment (EVSE) 208. In some embodiments, the EVSE 208 is connected to an external power source and the EVSE 208 can supply electrical power to the charge port 204 depending on a type of the external power source. The external power source can be a charging station or dock configured to charge the power storage device 202 installed in an electric vehicle. The external power source can be any of an Alternating Current (AC) power source and a Direct Current (DC) power source. In such cases, the EVSE 208 is configured to supply AC power when the EVSE 208 is connected to an AC power source, and the EVSE 208 is configured to supply DC power when the EVSE 208 is connected to a DC power source. In some embodiments, the EVSE 208 is connected to an AC power source. In some embodiments, the EVSE 208 is configured to transmit AC power from the AC power source to the charge port 204. In some embodiments, the EVSE 208 is configurable to convert the AC power to DC power and provide DC power to the charge port 204 (despite being connected to an AC power source). The power storage device 202, which may include one or more battery packs, usually requires only DC power for charging. In some embodiments, the charge port 204 is in communication with a plurality of terminals, such as proximity (PROX) terminal, pilot (PILOT) terminal, Protective-Earth (PE) terminal, High Voltage Positive (HV+) terminal and High Voltage Negative (HV−) terminal of the EVSE 208 to efficiently regulate the supply of the electrical power therethrough.

The system 200 also includes a DC fast charge contactor (FCC) 210 positioned in a DC path between the charge port 204 and the battery contactor 206. The FCC 210 is configured to supply the electrical power received from the EVSE 208 directly to the battery contactor 206 when the electric supply received by the charge port 204 is DC power, and to enable rapid charging of the power storage device 202. In some embodiments, the FCC 210 includes a set of relays or switches configured to move between an open state and a closed state to selectively control supplying electrical power to the battery contactor 206.

The system 200 also includes an on-board charger 212 positioned in an AC path between the charge port 204 and the battery contactor 206. In some embodiments, such as when the electric supply received by the charge port 204 is AC power, the on-board charger 212 is configured to convert the AC power into DC power and independently supply the DC power to the battery contactor 206 (e.g., separate from the FCC 210).

In some embodiments, the DC path between the charge port 204 and the battery contactor 206 includes two electric lines (e.g., electrical connections, including a positive electric line and a negative electric line) to facilitate direct supplying the DC power from the charge port 204 to the terminals of the power storage device 202. In some embodiments, the AC path between the charge port 204 and the battery contactor 206 includes two electric lines (e.g., electrical connections). A first electrical line (L1) is an active electric line, and a second electrical line (L2) is a neutral line (N). The on-board charger 212 located (e.g., positioned, disposed) in the AC path is configured to assist with conversion of AC power into DC power and supply the converted DC power to the terminals of the power storage device 202. In some embodiments, the on-board charger 212 includes an AC to DC converter.

The system 200 also includes a controller 214 configured to monitor operational parameters of the charge port 204, the battery contactor 206, the FCC 210, and the on-board charger 212. In some embodiments, controller 214 is also configured to control operational parameters of the charge port 204, the battery contactor 206, the FCC 210, the on-board charger 212 (such as closing or opening one or more switches at any of these components). In some embodiments, the controller 214 is connected to (e.g., in communication with, in communicative control of) components of the system 200 (depicted as dotted lines). For example, the controller 214 may be in communication with (e.g., receive information from) a set of sensors configured to detect operating parameters, such as current, voltage, temperature, instantaneous operating state, etc., of the FCC 210. In some embodiments, the controller 214 is configured to change the operating state of the FCC 210 (e.g., closing or opening one or more switches at the FCC 210) when an anomaly in the operating parameters of the FCC 210 is detected (e.g., in response to detection of an anomaly in the operating parameters of the FCC 210). The anomaly may be indicative of whether the FCC 210 is in a welded state or a faulty state. For example, the FCC 210 may be in a welded state or a faulty state if one or more contactors of the FCC 210 are fused together and unable to open and/or in a closed state but detected or determined to be in an open state by sensor(s) at the FCC 210. This may be a fault in the hardware (e.g., the contact is fused shut and unable to open, sensor failure, sensor damage), or may be a fault in communication (e.g., miscommunication between sensor(s) at the FCC 210 and the controller 214).

The system 200 further includes a PathSet contactor (PSC) 216 configured to control supplying the electrical power from the charge port 204 to the battery contactor 206. In some embodiments, the controller 214 is configured to control actuation (e.g., operation, switching) of the PSC 216 based on the operational parameters of at least the FCC 210 and the on-board charger 212. The controller 214 is configured to proactively determine if the FCC 210 is in the welded state, and control switching of operating states of the PSC 216 and/or the FCC 210 (e.g., switch between operating states of the PSC 216 and the FCC 210) to ensure safe and reliable charging process of the power storage device 202. The PSC 216 may be positioned appropriately in the DC path or the AC path to allow safe and reliable charging as well as discharging of the power storage device 202.

As shown in FIG. 2A, in some embodiments, the PSC 216 is positioned in the DC path between the charge port 204 and the FCC 210. In some embodiments, the PSC 216 includes at least a first switch and a second switch arranged in a parallel configuration with respect to one another. In some embodiments, the first switch is connected to a first diode D1 in its forward direction (anode side) to enable the direct supply of DC power to the battery contactor 206 through the FCC 210, and the second switch is connected to a second diode D2 in its reverse direction (cathode side) to allow supplying discharge energy of the power storage device 202 to a secondary power storage device or to an equipment via Vehicle-to-Everything (V2X) technology. The PSC 216 is positioned in the DC path to switch between the unidirectional paths created by the first and second diodes (e.g., diodes D1 and D2).

In some embodiments, such as when the EVSE 208 is configured to supply DC power (e.g., the EVSE 208 is connected to a DC power source, the EVSE 208 is configured to output DC power), the controller 214 controls switching of operating states of the PSC 216 and the FCC 210 such that the PSC 216 is closed towards the first diode D1 and the FCC 210 is in the closed state, enabling fast charging of the power storage device 202 via the DC path. Conversely, when the EVSE 208 is configured to supply AC power (e.g., the EVSE 208 is connected to an AC power source, the EVSE 208 is configured to output DC power), the controller 214 controls switching of the operating states of the PSC 216 and the FCC 210 such that the PSC 216 and the FCC 210 are in the open state, enabling charging of the power storage device 202 by AC power via the AC path (which converts the AC power to DC power prior to delivery to the power storage device 202).

In some embodiments, one or more components in the charging system 200 may be in a welded state (e.g., where one or more switches are welded in a closed position due to miscommunication or component malfunction). In such cases, the charging system 200 is configured to determine whether the electrical power received at the charge port 204 is DC power or AC power, and control switching of components within the charging system 200 to direct the electrical power via the correct electrical path (e.g., DC path or AC path) despite one or more components being in a welded state.

In some embodiments, in response to a determination that an anomaly is associated with the FCC 210 while the EVSE 208 is configured to provide AC power (e.g., the EVSE 208 is connected to an AC power source, the EVSE 208 is configured to output AC power), the controller 214 controls switching of operating states of the PSC 216 and the FCC 210 such that the PSC 216 is in its open state while the FCC 210 is in the closed state (e.g., the controller 214 opens the switches in the PSC 216 while the switches in the FCC 210 are welded in the closed state). For example, when the FCC 210 is in the welded state (e.g., one or more contacts of the FCC 210 are welded closed due to miscommunication or component failure) and power is supplied to the charge port 204, the open state of the PSC 216 interrupts the supply of power from the EVSE 208 to the battery contactor 206 via the DC path. In response to the open state of the PSC 216, the power is automatically routed to the AC path, which includes the on-board charger 212, configured to convert AC power into DC power, and DC power is supplied to the battery contactor 206 for safe charging of the power storage device 202.

Subsequently, within half cycle of the AC power (e.g., within half a period of the AC power) being supplied to the charge port, the controller 214 instructs the sensors to detect whether an operating voltage of the FCC 210 is stable (e.g., constant). In response to the sensors detecting that the operating voltage of the FCC 210 is stable (e.g., constant), the controller 214 determines that the electrical power supplied to the charge port 204 is DC power. In response to the sensors detecting that the operating voltage of the FCC 210 is not stable (e.g., not constant), the controller 214 determines that the electrical power supplied to the charge port 204 is AC power.

In response to a determination (e.g., by the sensors, by the controller 214) that the operating voltage of the FCC 210 is not stable (e.g., electrical power supplied to the charge port 204 is AC power), the controller 214 switches the first switch of the PSC 216 to its open state and also switches the FCC 210 to its open state in order to completely interrupt/disable the supply of the AC power to the battery contactor 206 through the FCC 210 (e.g., through the DC path) and direct the AC power to the AC path.

In some embodiments, such as when the FCC 210 is in a welded state (e.g., one or more contacts of the FCC 210 are welded closed due to miscommunication or component failure), the controller 214 is configured to detect an operating voltage of the power storage device 202 and a peak voltage of the AC power supplied by the EVSE 208 using voltage sensors appropriately positioned in the system 200.

In response to a determination that operating voltage of the power storage device 202 is higher that the peak voltage of the AC voltage, the controller 214 determines that the AC charging process is safe even when (e.g., if) an anomaly is detected in the FCC 210 (e.g., switches in the FCC 210 are welded in a closed position), and the controller 214 switches the first diode D1 of the PSC 216 and the contacts of the FCC 210 to closed states to enable charging of the power storage device 202 via the AC path. Since the operating voltage of the power storage device 202 is higher that the peak voltage of the AC voltage, the first diode D1 of the PSC 216 is in reverse bias, thereby blocking transmission of AC power via the DC path (e.g., when the first diode D1 of the PSC 216 is in reverse bias due to the operating voltage of the power storage device 202 being higher that the peak voltage of the AC voltage, the first diode D1 of the PSC 216 impedes the flow of electricity through the first diode D1 of the PSC 216).

In response to a determination that operating voltage of the power storage device 202 is lower than or equal to the peak voltage of the AC power, the controller 214 determines, within a half cycle of the AC power, that the AC charging process is unsafe when (e.g., if) an anomaly is detected in the FCC 210 (e.g., switches in the FCC 210 are welded in a closed position) and switches any or a combination of the PSC 216 and the FCC 210 to open states to disable supplying the AC power (e.g., via the DC path) to the terminals of the power storage device 202.

Accordingly, the controller 214 controls switching of operating states of the PSC 216 and the FCC 210 to efficiently prevent directly supplying (e.g., via the DC path) AC power to the terminals of the power storage device 202. This effectively prevents an occurrence of damage to the power storage device 202 and the EVSE 208 (including any external power source that may be connected to the EVSE 208) due to the direct supply of AC power to the power storage device 202.

FIG. 2B illustrates another embodiment of the present disclosure, in which a 4Quadrant switch 250 is selected as the PathSet contactor (e.g., the PathSet contactor includes 4Quadrant switch 250, the PathSet contactor is a 4Quadrant switch 250). In some embodiments, the 4Quadrant switch 250 is positioned in the DC path between the charge port 204 and the FCC 210. In some embodiments, the 4Quadrant switch 250 includes a first Insulated-Gate Bipolar Transistor (IGBT) switch and a second IGBT switch arranged in a parallel configuration with respect to one another. In some embodiments, the first IGBT switch is connected to a first diode in its forward direction (anode side) to enable directly supplying DC power to the battery contactor 206 through the FCC 210. In some embodiments, the second IGBT switch is connected to a second diode in its forward direction (anode side) in an opposite direction of the first IGBT switch to allow supplying discharge energy of the power storage device 202 to a secondary power storage device or to an equipment via Vehicle-to-Everything (V2X) technology.

In some embodiments, such as when the EVSE 208 is configured to provide DC power (e.g., the EVSE 208 is connected to a DC power source, the EVSE 208 is configured output DC power), the controller 214 controls switching of the operating states of the 4Quadrant switch 250 and the FCC 210 such that the 4Quadrant switch 250 is closed towards the first diode and the FCC 210 is in the closed state, thereby enabling the DC power to be directly supplied to the terminals of the power storage device 202 via the DC path. Conversely, when the EVSE 208 is configured to provide AC power (e.g., the EVSE 208 is connected to an AC power source, the EVSE 208 is configured output AC power), the controller 214 controls switching of the operating states of the 4Quadrant switch 250 and the FCC 210 such that the 4Quadrant switch 250 and the FCC 210 are in the open state, thereby enabling the AC power to be supplied to the on-board charger 212 to allow conversion of said AC power into DC power and supplying the converted DC power to the terminals of the power storage device 202 (e.g., via the AC path).

In some embodiments, one or more components in the charging system 200 may be in a welded state (e.g., where one or more switches are welded in a closed position due to miscommunication or component malfunction). In such cases, the charging system 200 is configured to determine whether the electrical power received at the charge port 204 is DC power or AC power, and control switching of components within the charging system 200 to direct the electrical power via the correct electrical path (e.g., DC path or AC path) despite one or more components being in a welded state.

In some embodiments, in response to a determination that an anomaly is associated with the FCC 210 while the EVSE 208 is configured to provide AC power (e.g., the EVSE 208 is connected to an AC power source, the EVSE 208 is configured to output AC power), the controller 214 controls switching of operating states of the 4Quadrant switch 250 such that the 4Quadrant switch 250 is in its open state, thereby interrupting the flow of electricity in the DC path. For example, when the FCC 210 is in the welded state (e.g., one or more contacts of the FCC 210 are closed) and AC power is supplied to the charge port 204, the open state of the 4Quadrant switch 250 interrupts the supply of the AC power from the EVSE 208 to the battery contactor 206, thereby ensuring that the AC power is automatically routed to the AC path, in which the on-board charger 212 converts said AC power into DC power and supplies the converted DC power to the battery contactor 206 for safe charging of the power storage device 202.

In another example, in the case where AC power is required to be supplied to the charge port 204 in a next cycle and the FCC 210 is in the welded state (e.g., one or more contacts of the FCC 210 are closed) due to miscommunication in the circuitry that has enabled the supply of the AC power towards the FCC 210, the controller 214 switches the first IGBT switch of the 4Quadrant switch 250 to its closed state towards the first diode and switches the FCC 210 to its closed state. Thereafter, within a half cycle of the AC power, the controller 214 instructs the sensors to detect whether the operating voltage of the FCC 210 is stable (e.g., constant). In response to the sensors detecting that the operating voltage of the FCC 210 is stable (e.g., constant), the controller 214 determines that the electrical power supplied to the charge port 204 is DC power. In response to the sensors detecting that the operating voltage of the FCC 210 is not stable (e.g., not constant), the controller 214 determines that the electrical power supplied to the charge port 204 is AC power.

In response to a determination (e.g., by the sensors, by the controller 214) that the operating voltage of the FCC 210 is not stable (e.g., electrical power supplied to the charge port 204 is AC power), the controller 214 switches the first IGBT switch of the 4Quadrant switch 250 and the FCC 210 to open states in order to completely disable the supply of the AC power to the battery contactor 206 through the FCC 210.

In some embodiments, such as when the FCC 210 is in a welded state (e.g., one or more contacts of the FCC 210 are welded closed due to miscommunication or component failure), the controller 214 is configured to detect an operating voltage of the power storage device 202 and a peak voltage of the AC power supplied by the EVSE 208 using voltage sensors appropriately positioned in the system 200. In response to a determination that the operating voltage of the power storage device 202 is higher than the peak voltage of the AC voltage, the controller 214 determines that the AC charging process is safe even when (e.g., if) an anomaly is detected in the FCC 210 (e.g., switches in the FCC 210 are welded in a closed position), and the controller 214 switches the first IGBT switch of the 4Quadrant switch 250 and the contacts of the FCC 210 to closed states to enable charging of the power storage device 202 via the AC path. Since the operating voltage of the power storage device 202 is higher that the peak voltage of the AC voltage, first IGBT switch of the 4Quadrant switch 250 acts as a diode in reverse bias, thereby blocking transmission of AC power via the DC path.

In response to a determination that the operating voltage of the power storage device 202 is lower than or equal to the peak voltage of the AC power, the controller 214 determines, within a half cycle of the AC power, that the AC charging process is unsafe when (e.g., if) an anomaly is detected in the FCC 210 (e.g., switches in the FCC 210 are welded in a closed position). The controller 214 switches any of the 4Quadrant switch 250 and the FCC 210 to open states to disable the direct supply of AC power to the terminals of the power storage device 202 (e.g., via the DC path). Thus, the controller 214 controls switching of operating states of the 4Quadrant switch 250 and the FCC 210 to efficiently prevent directly supplying AC power to the terminals of the power storage device 202. Consequently, this system 200 effectively prevents an occurrence of damage to the power storage device 202 and the EVSE 208 (including any external power source that may be connected to the EVSE 208) due to the direct supply of AC power to the power storage device 202.

FIG. 2C illustrates another embodiment of the present disclosure, in which the PathSet contactor is an AC/DC contactor 260 (e.g., the PathSet contactor includes an AC/DC contactor 260, also referred to herein as an AC/DC switch 260). In some embodiments, the AC/DC contactor 260 is positioned downstream of the charge port 204 at an intersection of the DC path and the AC path. In some embodiments, the AC/DC contactor 260 includes a relay or a switch configured to selectively switch supplying of the electrical power from the EVSE 208 between the DC path and the AC path (e.g., between utilizing the DC path or utilizing the AC path). In this configuration, the system 200 also includes a diode 262 positioned in the positive line on the DC side of the on-board charger 212 downstream of the on-board charger 212. Thus, control of the electrical path of electricity transmitted between the EVSE 208 and power storage device 202 (to travel along the DC path or the AC path) is achieved by switching the AC/DC contactor 260 to either be in contact with the DC path or the AC path.

In some embodiments, such as when the EVSE 208 is configured to provide DC power (e.g., the EVSE 208 is connected to a DC power source, the EVSE 208 is configured to output DC power), the controller 214 controls switching of operating states of the AC/DC contactor 260, the FCC 210 and the diode 262 such that the AC/DC contactor 260 is connected to the DC path, the FCC 210 is in its closed state and the diode 262 is in reverse bias. This enables the DC power to be directly supplied to the terminals of the power storage device 202 while preventing supplying the DC power to the on-board charger 212 located in the AC path.

In some embodiments, such as when the EVSE 208 is configured to provide AC power (e.g., the EVSE 208 is connected to an AC power source, the EVSE 208 is configured to output AC power), the controller 214 controls switching of operating states of the AC/DC contactor 260 and the FCC 210 such that the AC/DC contactor 260 is connected to the AC path, the FCC 210 is in its open state and the diode 262 is in forward bias. This enables the AC power to be supplied to the on-board charger 212 for conversion into DC power and allows the converted DC power to be supplied to the terminals of the power storage device 202.

In some embodiments, in response to a determination, by the controller 214, that an unexpected anomaly is associated with the FCC 210 or the diode while EVSE 208 is configured to provide AC power (e.g., the EVSE 208 is connected to an AC power source, the EVSE 208 is configured to output AC power), the controller 214 controls switching of operating states of the AC/DC contactor 260 and the FCC 210 such that the AC/DC contactor 260 is connected to the AC path and the diode 262 is in forward bias, thereby enabling transmission of electrical power along the AC path. For example, when the FCC 210 is in the welded state and AC power is supplied to the charge port 204, the AC/DC contactor 260 being connected to the AC path and forward biasing of the diode 262 ensure that the AC power is automatically routed to the AC path. The on-board charger 212 converts the AC power into DC power and supplies the converted DC power to the battery contactor 206 for safe charging of the power storage device 202.

For example, when the FCC 210 is in the welded state and AC power is required to be supplied to the charge port 204 in a next cycle with some miscommunication in the circuitry that has enabled supplying the AC power towards the FCC 210, the controller 214 switches the AC/DC contactor 260 to the DC path and the diode 262 in the forward bias for one half cycle of the AC power, after which the controller 214 switches the FCC 210 to its open state and connects the AC/DC contactor 260 to the AC path, thereby enabling the supply of the AC power to the terminals of the power storage device 202. Thus, the controller 214 controls switching of operating states of the AC/DC contactor 260, the FCC 210 and the diode 262 to prevent directly supplying AC power to the terminals of the power storage device 202. As a result, the system 200 effectively prevents damage to the power storage device 202 and the EVSE 208 (including any the external power source that may be connected to the EVSE 208) due to an undesired direct supply of AC power to the power storage device 202.

FIG. 2D depicts another embodiment of the present disclosure, in which the PathSet contactor is an AC contactor 270 (e.g., the PathSet contactor includes an AC contactor 270) that is positioned downstream of the on-board charger 212 in the AC path. The AC contactor 270 is configured to function in a complementary operation (e.g., inverse operation) to the FCC 210 such that the AC contactor 270 automatically switches to its open state when the FCC 210 is in its closed state, and the AC contactor 270 automatically switches to its closed state when the FCC 210 is in its open state.

In some embodiments, the controller 214 is configured to determine whether a precondition is met. In some embodiments, the precondition requires that the FCC 210 is in its open state and the AC contactor 270 is in its closed state (e.g., the precondition is met when the FCC 210 is in its open state and the AC contactor 270 is in its closed state). In response to a determination, by the controller 214, that the precondition is met, the controller 214 generates a preconditioning event signal. In response to a determination, by the controller 214, that the precondition is not met, the controller 214 generates a preconditioning failure signal and the controller controls the charge port 204 to disable supplying the electric current from the EVSE 208 to any of the FCC 210 and the on-board charger 212. In some embodiments, the absence of the preconditioning event signal signifies to the controller that the precondition is not met.

In some embodiments, such as when the EVSE 208 is configured to provide DC power (e.g., the EVSE 208 is connected to a DC power source, the EVSE 208 is configured to output DC power), the controller 214 controls switching of operating states of the AC contactor 270 and the FCC 210 such that the AC contactor 270 is in its open state and the FCC 210 is in its closed state. This enables the DC power to be directly supplied to the terminals of the power storage device 202 while preventing supplying the DC power to the on-board charger 212 located in the AC path.

In some embodiments, such as when the EVSE 208 is configured to provide AC power (e.g., the EVSE 208 is connected to a AC power source, the EVSE 208 is configured to output AC power), the controller 214 controls switching of operating states of the AC contactor 270 and the FCC 210 such that the AC contactor 270 is in its closed state and the FCC 210 is in its open state. This enables the AC power to be supplied to the on-board charger 212 for conversion into DC power and thereafter, to supply the DC power to the terminals of the power storage device 202.

In some embodiments, such as when the controller 214 determines that an anomaly is associated with the FCC 210 while the EVSE 208 is configured to provide AC power (e.g., the EVSE 208 is connected to a AC power source, the EVSE 208 is configured to output AC power), the controller 214 generates a preconditioning failure signal and disables supplying the electrical power from the EVSE 208 to any of the FCC 210 and the on-board charger 212. For example, when the FCC 210 is in the welded state and AC power is required to be supplied to the charge port 204 in a next cycle with some miscommunication in the circuitry that has enabled the supply of the AC power towards the FCC 210, the controller 214 generates a preconditioning failure signal and disables the supply of the electric current from the EVSE 208 to any of the FCC 210 and the on-board charger 212. In some embodiments, a fuse may be provided upstream of the terminals of the power storage device 202 to improve safety in case of generation of the preconditioning failure signal by the controller 214. Consequently, the system 200 is configured to prevent damage to the power storage device 202 and the EVSE 208 (including any external power source that may be connected to the EVSE 208) due to the direct supply of AC power to the power storage device 202.

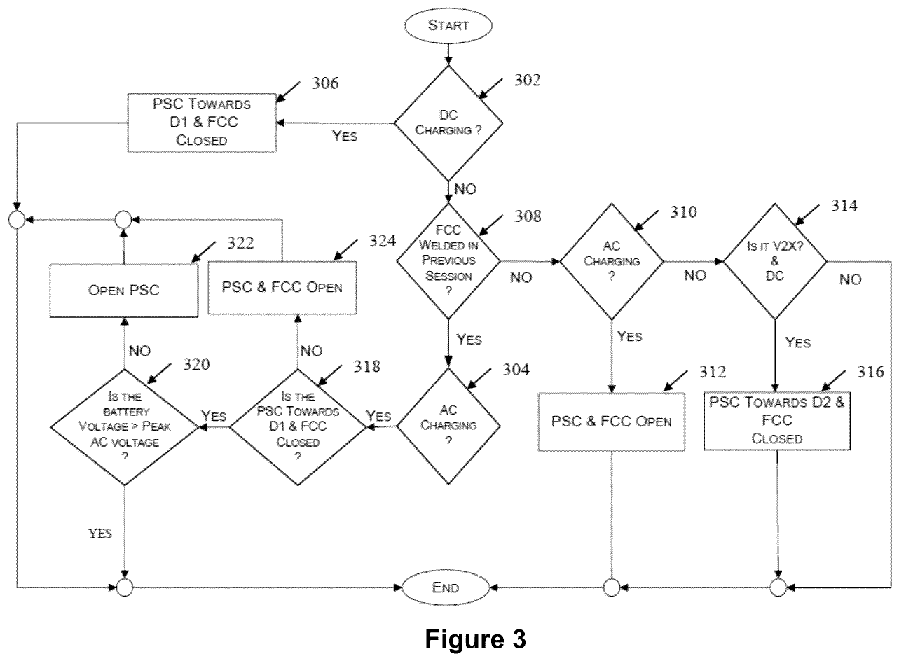

FIG. 3 illustrates a flowchart depicting the methodology of the charging system 200 when the PathSet Contactor (PSC) 216 is positioned in the DC path between the charge port 204 and the FCC 210. The controller 214 firstly detects whether the charge port 204 is connected to a DC power source or an AC power source (e.g., connected to an external AC or DC power source through the EVSE 208 or connected to an EVSE 208 that is configured to output AC and/or DC power) to determine whether the power storage device 202 is to be charged via DC charging, at step 302, or via AC charging, at step 304. At step 302, if the controller determines that the power storage device 202 is to be charged by DC power, the controller 214, at step 306, closes the PSC 216 towards the first diode D1 and the FCC 210 is closed to enable DC charging of the power storage device 202. However, if the controller determines that the power storage device 202 is to be charged by AC power, i.e., step 304, the controller 214, at step 308, checks whether the FCC 210 was associated with an anomaly in a previous session. For example, at step 308, the controller 214 may determine whether the FCC 210 was present in the welded state in a previous session. Thereafter, the controller 214 again determines, at step 310, if the power storage device 202 is to be charged by AC power, and opens the FCC 210 and the PSC 216 to enable AC charging of the power storage device, at step 312. If the controller, at step 302, determines that the power storage device 202 is not to be charged by DC power, the controller 214 may directly proceed to step 308. Further, if at step 310, the controller determines that the power storage device 202 is not to be charged by AC power, the controller 214 may determine if DC charging or charging of an auxiliary/secondary device via V2X technology is to be performed, at step 314. Thereafter, the controller 214 may, at step 316, close the PSC 216 towards the second diode D2 and also close the FCC 210 to enable charging of the auxiliary/secondary device via V2X technology.

After step 304, the controller 214 may also determine, at step 318, whether the PSC is in its closed state towards the first diode D1 and the FCC 210 is in its closed state; and at step 320, detect whether the voltage of the power storage device 202 is greater than the peak AC voltage. If the condition of step 320 is not satisfied (e.g., the voltage of the power storage device 202 is not greater than the peak AC voltage), the controller, at step 322, opens the PSC 216 and enables AC charging of the power storage device 202 via the AC path. However, if the condition of step 320 is satisfied (e.g., the voltage of the power storage device 202 is greater than the peak AC voltage), the controller prevents charging of the power storage device 202. Also, when the condition of step 318 is not satisfied (e.g., the PSC is not in its closed state towards the first diode D1 and the FCC 210 is not in its closed state), the controller opens the PSC 216 and the FCC 210 to allow AC charging of the power storage device 202 via the AC path. Thus, the PSC 216 effectively controls safe charging of the power storage device 202, while safeguarding the charging process from any anomaly associated with the FCC 210 to prevent damage of the power storage device 202 and/or the EVSE 208 and any external power source that may be connected to the EVSE 208. The PSC 216 also allows for charging of the power storage device 202 by AC as well as DC charging stations through the single charge port 204, thereby eliminating the requirement of separate charge ports for enabling AC charging and DC charging of the power storage device 202.

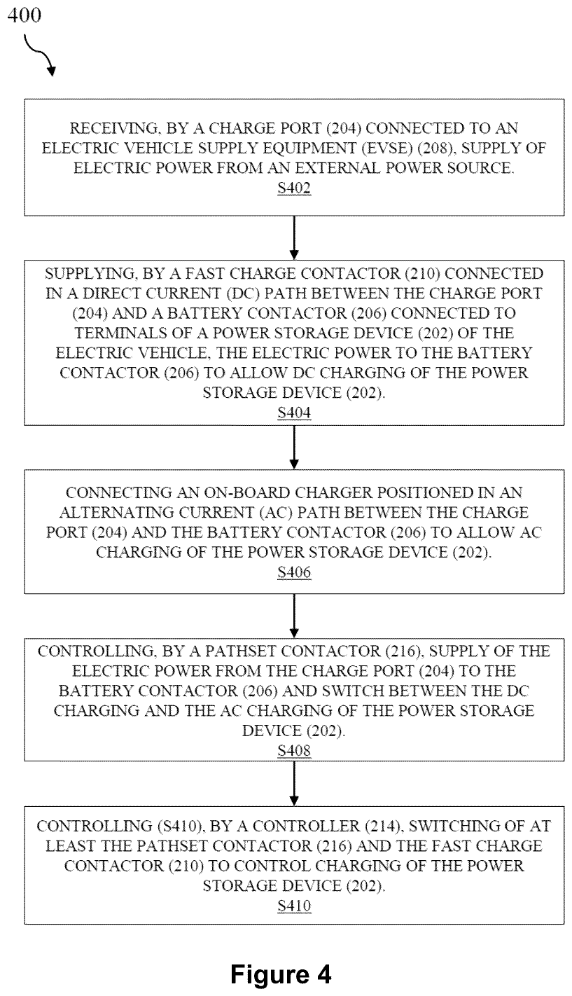

FIG. 4 illustrates a flowchart showing various processes involved in a charging method for the power storage device 202 installed in a vehicle. The charging method 400 includes, at step S402, receiving, by a charge port 204 connected to an electric vehicle supply equipment (EVSE) 208, electrical power from an external power source. Thereafter, at step S404, the electrical power is supplied, by the DC fast charge contactor (FCC) 210 connected in a Direct Current (DC) path between the charge port 204 and a battery contactor 206 connected to terminals of the power storage device 202 of the vehicle, to the battery contactor 206 to allow DC charging of the power storage device 202. The method 400 includes a step S406 of connecting an on-board charger 212 positioned in an Alternating Current (AC) path between the charge port 204 and the battery contactor 206 to allow AC charging of the power storage device 202. Thereafter, at step S408, the method 400 involves controlling, by a PathSet contactor (PSC) 216, 250, 260, 270, the electrical power from the charge port 204 to the battery contactor 206 and switch between the DC charging and the AC charging of the power storage device 202. The method 400 also includes a step S410 of controlling, by a controller 214, switching of at least the PSC 216 and the FCC 210 to control charging of the power storage device 202. The step S410 may include controlling the electrical power between the DC path and the AC path (e.g., between utilizing the DC path or utilizing the AC path) based on detection of an anomaly in the FCC 210.

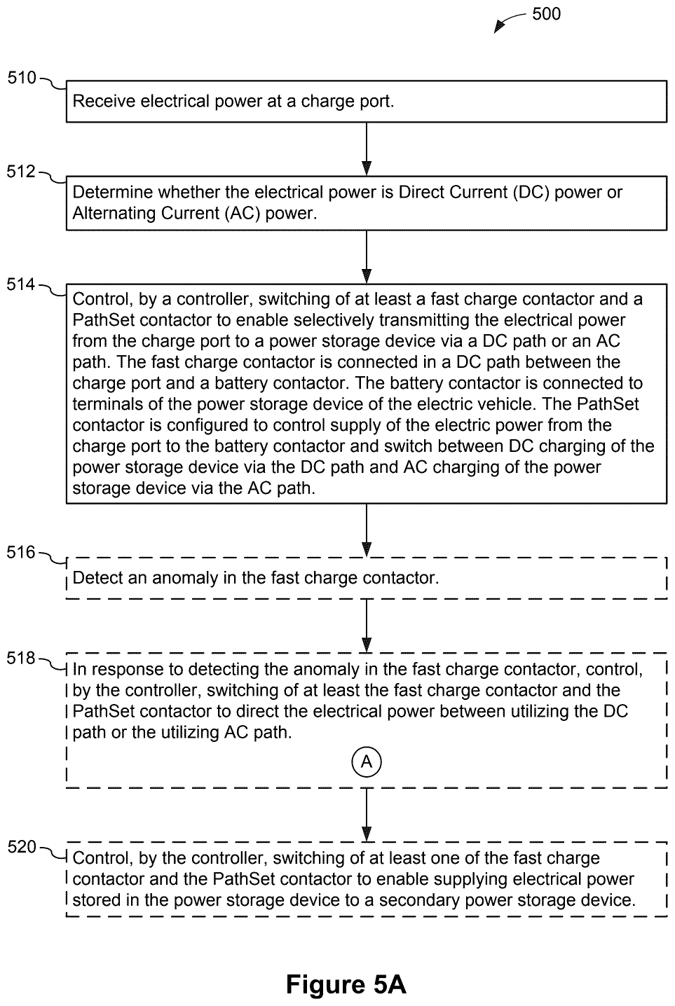

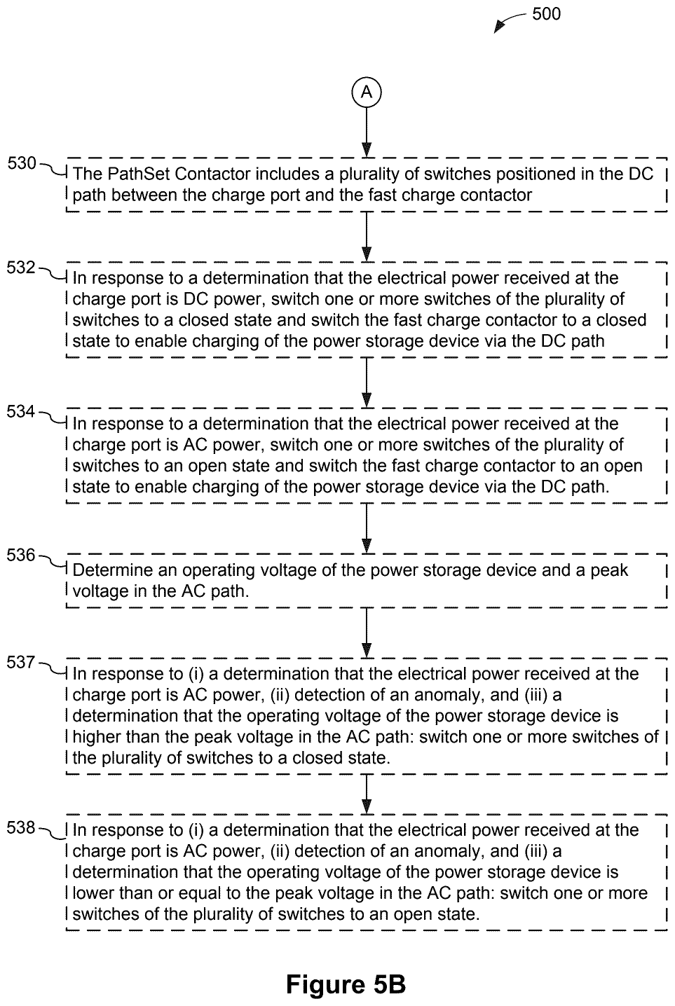

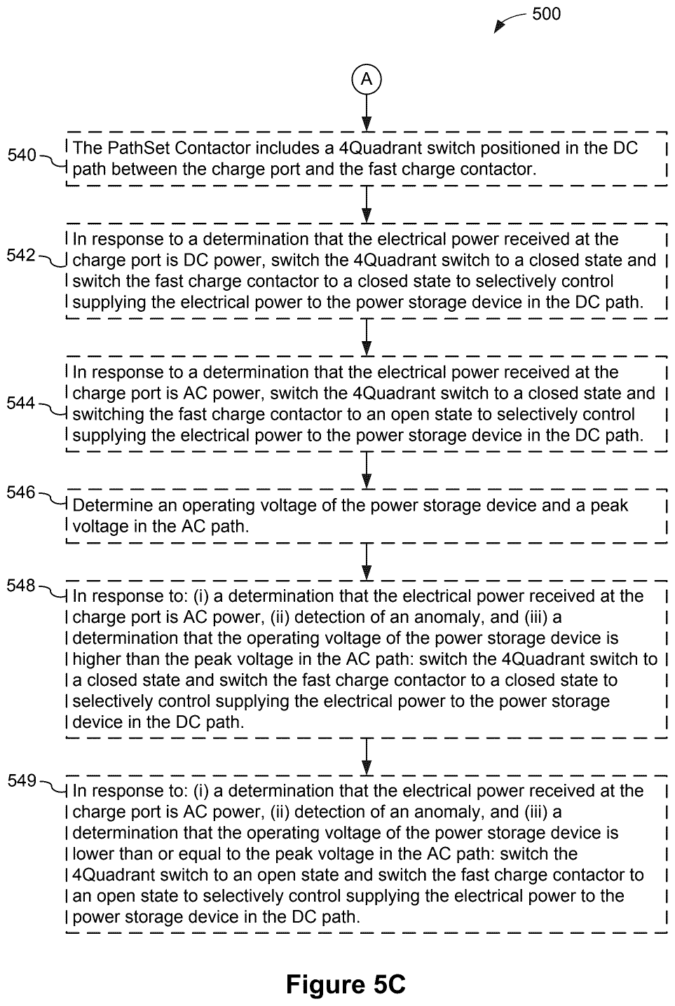

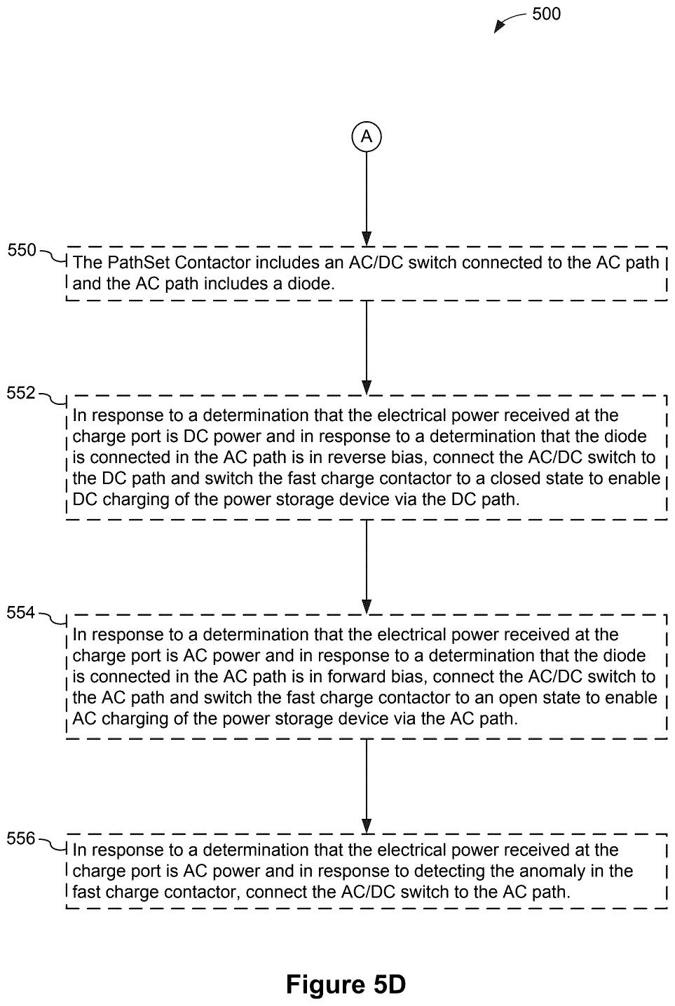

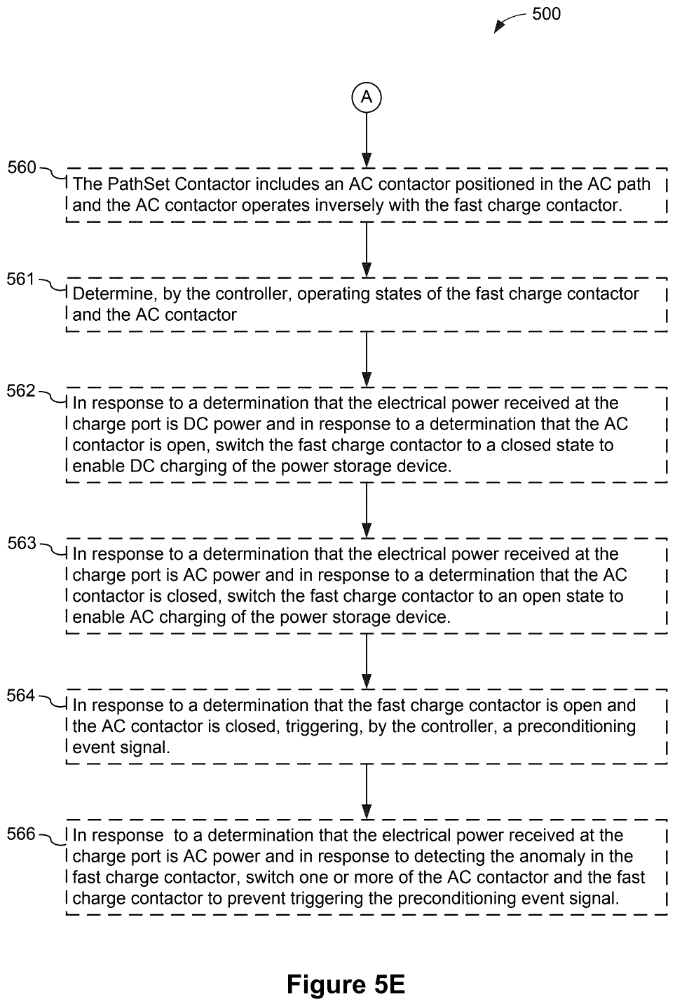

FIGS. 5A-5E illustrate a flowchart showing a method 500 of charging a power storage device 202 installed in a vehicle. The method 500 includes receiving (step 510) electrical power at a charge port (e.g., charge port 204) and determining (step 512) whether the electrical power is DC power or AC power. The method 500 also includes controlling (step 514), by a controller (e.g., controller 214), switching of at least a fast charge contactor (e.g., FCC 210 and a PathSet contactor (PSC) to enable selectively transmitting the electrical power from the charge port 204 to a power storage device (e.g., power storage device 202) via a DC path or an AC path. The fast charge contactor 210 is connected in a DC path between the charge port 204 and a battery contactor (e.g., battery contactor 206). The battery contactor 206 is connected to terminals of the power storage device of the electric vehicle. The PathSet contactor is configured to control the supply of the electric power from the charge port 204 to the battery contactor 206 and switch between DC charging of the power storage device 202 via the DC path and AC charging of the power storage device 202 via the AC path.

In some embodiments, the method 500 further includes detecting (step 516) an anomaly in the fast charge contactor 210 and in response to detecting the anomaly in the fast charge contactor 210, controlling (step 518) by the controller 214, switching of at least the fast charge contactor 210 and the PathSet contactor (e.g., PSC 216, 250, 260, 270) to direct the electrical power between utilizing the DC path or utilizing the AC path. In some embodiments, detecting (step 516) an anomaly in the fast charge contactor 210 includes determining by the controller 214, that one or more contacts (e.g., at least one contact) of the fast charge contactor 210 are in a welded state.

In some embodiments, the method 500 also includes controlling (step 520), by the controller 214, switching of at least one of the fast charge contactor 210 and the PathSet contactor to enable supplying electrical power stored in the power storage device 202 to a secondary power storage device.

In some embodiments, the PathSet Contactor 216 includes (step 530) a plurality of switches that is positioned in the DC path between the charge port 204 and the fast charge contactor 210 (shown in FIG. 2A). The method 500 further includes, in response to a determination that the electrical power received at the charge port is DC power, switching (step 532) one or more switches of the plurality of switches (e.g., at least switch connected to diode D1) to a closed state and switching the fast charge contactor 210 to a closed state to enable charging of the power storage device 202 via the DC path. The method 500 also includes, in response to a determination that the electrical power received at the charge port is AC power, switching (step 534) one or more switches of the plurality of switches (e.g., at least switch connected to diode D1) to an open state and switching the fast charge contactor 210 to an open state to enable charging of the power storage device 202 via the DC path. The method 500 also includes determining (step 536) an operating voltage of the power storage device 202 and a peak voltage in the AC path. The method 500 further includes, in response to (i) a determination that the electrical power received at the charge port is AC power, (ii) detection of an anomaly, and (iii) a determination that the operating voltage of the power storage device is higher than the peak voltage in the AC path: switching (step 537) one or more switches of the plurality of switches (e.g., at least the switch that is connected to diode D1) to a closed state. The method 500 also includes, in response to (i) a determination that the electrical power received at the charge port is AC power, (ii) detection of an anomaly, and (iii) a determination that the operating voltage of the power storage device is lower than or equal to the peak voltage in the AC path: switching (step 538) one or more switches of the plurality of switches (e.g., at least the switch that is connected to diode D1) to an open state.

In some embodiments, the PathSet Contactor includes (step 540) a 4Quadrant switch (e.g., 4Quadrant switch 250) that is positioned in the DC path between the charge port 204 and the fast charge contactor 210. The method 500 further includes, in response to a determination that the electrical power received at the charge port 204 is DC power, switching (step 542) the 4Quadrant switch 250 to a closed state and switching the fast charge contactor 210 to a closed state to selectively control supplying the electrical power to the power storage device 202 in the DC path. The method 500 also includes, in response to a determination that the electrical power received at the charge port 204 is AC power, switching (step 544) the 4Quadrant switch 250 to a closed state and switching the fast charge contactor 210 to an open state to selectively control supplying the electrical power to the power storage device 202 in the DC path. The method 500 also includes determining (step 546) an operating voltage of the power storage device 202 and a peak voltage in the AC path. The method 500 also includes, in response to: (i) a determination that the electrical power received at the charge port is AC power, (ii) detection of an anomaly, and (iii) a determination that the operating voltage of the power storage device 202 is higher than the peak voltage in the AC path: switching (step 548) the 4Quadrant switch 250 to a closed state and switching the fast charge contactor 210 to a closed state to selectively control supplying the electrical power to the power storage device 202 in the DC path. The method 500 further includes, in response to: (i) a determination that the electrical power received at the charge port is AC power, (ii) detection of an anomaly, and (iii) a determination that the operating voltage of the power storage device is lower than or equal to the peak voltage in the AC path: switching (step 549) the 4Quadrant switch 250 to an open state and switching the fast charge contactor 210 to an open state to selectively control supplying the electrical power to the power storage device in the DC path.

In some embodiments, the PathSet Contactor includes an AC/DC switch (e.g., AC/DC switch 260, also referred to as AC/DC contactor 260) connected to the AC path and the AC path includes a diode (e.g., diode 262). The method 500 further includes, in response to a determination that the electrical power received at the charge port 204 is DC power and in response to a determination that the diode 262 is connected in the AC path is in reverse bias, connecting (step 552) the AC/DC switch 260 to the DC path (e.g., closing the AC/DC switch 260 as shown in FIG. 2E) and switching the fast charge contactor 210 to a closed state to enable DC charging of the power storage device 202 via the DC path. The method 500 also includes, in response to a determination that the electrical power received at the charge port 204 is AC power and in response to a determination that the diode 262 is connected in the AC path is in forward bias, connecting (step 554) the AC/DC switch 260 to the AC path (e.g., opening the AC/DC switch 260 as shown in FIG. 2E) and switching the fast charge contactor 210 to an open state to enable AC charging of the power storage device 202 via the AC path. The method 500 also includes in response to a determination that the electrical power received at the charge port 204 is AC power and in response to detecting the anomaly in the fast charge contactor 210, connecting (step 556) the AC/DC switch 260 to the AC path (e.g., opening the AC/DC switch 260 as shown in FIG. 2E).

In some embodiments, the PathSet Contactor includes (step 560) an AC contactor positioned (e.g., AC contactor 270) positioned in the AC path and the AC contactor 270 operates inversely with the fast charge contactor 210. The method 500 further includes determining (step 561), by the controller, operating states of the fast charge contactor 210 and the AC contactor 270. The method 500 also includes, in response to a determination that the electrical power received at the charge port 204 is DC power and in response to a determination that the AC contactor 270 is open, switching (step 562) the fast charge contactor 210 to a closed state (thereby switching the AC contactor 270 to an open state) to enable DC charging of the power storage device 202. The method 500 further includes, in response to a determination that the electrical power received at the charge port 204 is AC power and in response to a determination that the AC contactor 270 is closed, switching (step 564) the fast charge contactor 210 to an open state (thereby switching the AC contactor 270 to a closed state) to enable AC charging of the power storage device. The method 500 further includes, in response to a determination that the electrical power received at the charge port is AC power and in response to detecting the anomaly in the fast charge contactor, switching (step 566) one or more of the AC contactor 270 and the fast charge contactor 210 to prevent triggering the preconditioning event signal.

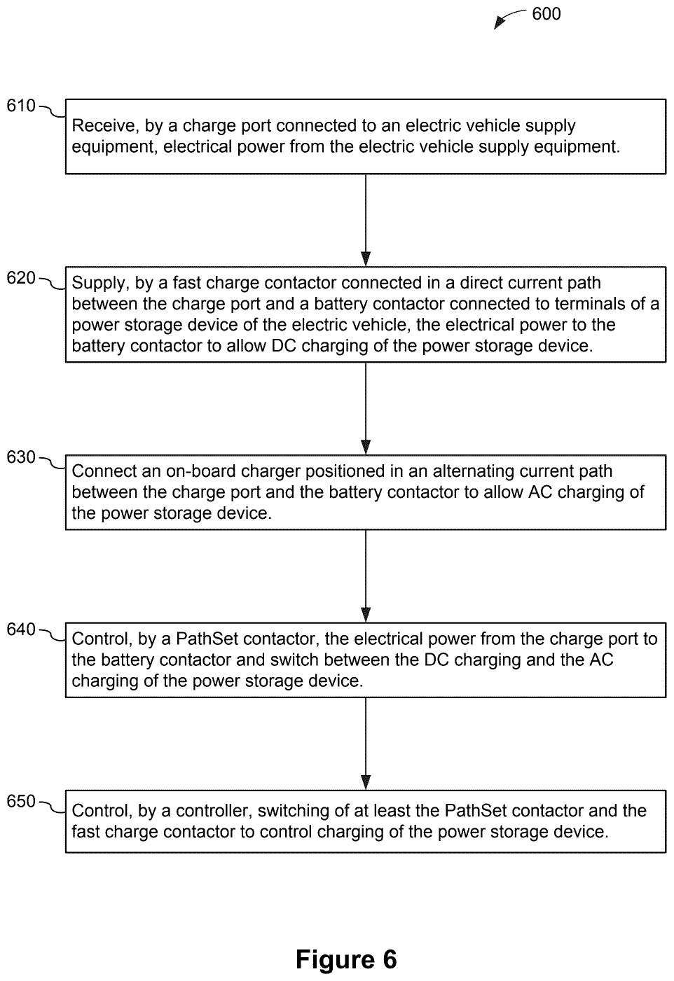

FIG. 6 illustrates a flowchart showing a method 600 of charging a power storage device 202 installed in a vehicle. The charging method 600 includes receiving (step 610), by a charge port 204 connected to an electric vehicle supply equipment (EVSE) 208, supply of electrical power from the electric vehicle supply equipment. The method 600 also includes supplying (step 620), by a fast charge contactor (FCC) 210 that is connected in a Direct Current (DC) path between the charge port 204 and a battery contactor 206 connected to terminals of the power storage device 202 of the vehicle, the electrical power to the battery contactor 206 to allow DC charging of the power storage device 202. The method 600 further includes connecting (step 630) an on-board charger 212 positioned in an Alternating Current (AC) path between the charge port 204 and the battery contactor 206 to allow AC charging of the power storage device 202. The method 600 also includes controlling (step 640), by a PathSet contactor (PSC) 216, 250, 260, 270, the electrical power from the charge port 204 to the battery contactor 206 and switch between the DC charging and the AC charging of the power storage device 202. The method 600 also includes controlling (step 650), by a controller 214, switching of at least the PSC 216 and the FCC 210 to control charging of the power storage device 202. In some embodiments, step 610 includes controlling the electrical power between utilizing the DC path or utilizing the AC path based on detection of an anomaly in the FCC 210.

### Turning Now to Some Example Implementations.

(A1) In one aspect, some implementations include a charging system (e.g., charging system 200, shown in FIGS. 2A-2D), for an electric vehicle include: a charge port connected to an electric vehicle supply equipment (EVSE) to receive electric power from an external power source; a battery contactor connected to terminals of a power storage device of the electric vehicle; a fast charge contactor connected in a Direct Current (DC) path between the charge port and the battery contactor to enable DC charging of the power storage device; an on-board charger connected in an Alternating Current (AC) path between the charge port (and the battery contactor, and configured to enable AC charging of the power storage device; a PathSet Contactor configured to control the supply of the electric power from the charge port to the battery contactor and switch between the DC charging and the AC charging of the power storage device; and a controller configured to control switching of at least the PathSet Contactor and the fast charge contactor to control charging of the power storage device.
(A2) The charging system of A1, where the PathSet Contactor is configured to control the supply of the electric power between the DC path and the AC path based on detection of an anomaly in the fast charge contactor.
(A3) The charging system of A1 or A2, where the PathSet Contactor includes a plurality of switches positioned in the DC path between the charge port and the fast charge contactor. The PathSet Contactor is configured to switch between unidirectional paths generated by a plurality of diodes (D1, D2) to selectively control supplying of the electric power to the power storage device in the DC path, and to control supplying of electric energy of the power storage device to a secondary power storage device. The controller is configured to open the PathSet contactor when an anomaly in the fast charge contactor is detected and the external power source connected to the charge port is an AC power source. An example is provided with respect to FIG. 2A.
(A4) The charging system of any of A1-A3, where the controller is configured to: close the PathSet Contactor when an operating voltage of the power storage device is higher that a peak voltage in the AC path and open the PathSet Contactor when the operating voltage of the power storage device is lower than the peak voltage in the AC path.
(A5) The charging system of any of A1-A4, where the PathSet Contactor is a 4Quadrant switch positioned in the DC path between the charge port and the fast charge contactor to selectively control supplying the electric power to the power storage device in the DC path, and control supplying the electric energy of the power storage device to a secondary power storage device. The controller is configured to operate the 4Quadrant switch as open when the anomaly in the fast charge contactor is detected and the external power source connected to the charge port is an AC power source. An example is provided with respect to FIG. 2B.
(A6) The charging system of any of A1-A5, where the PathSet Contactor is an AC/DC switch configured to switch the supply of the electric power from the charge port between the DC path and the AC path to enable selective switching between the DC charging and the AC charging of the power storage device.
(A7) The charging system of any of A1-A6, further including a diode positioned downstream of the on-board charger in the AC path. The controller is configured to: close the fast charge contactor to enable the DC charging of the power storage device when the AC/DC switch is connected to the DC path and the diode is in reverse bias; open the fast charge contactor to enable the AC charging of the power storage device when the AC/DC switch is connected to the AC path and the diode is in forward bias; and open the AC/DC switch when the anomaly in the fast charge contactor is detected or an anomaly is detected in the diode and the external power source connected to the charge port (204) is an AC power source. An example is provided with respect to FIG. 2C.
(A8) The charging system of any of A1-A7, where the PathSet Contactor is an AC contactor positioned downstream of the on-board charger in the AC path and operating complementary with the fast charge contactor. The controller is configured to: determine operating states of the fast charge contactor and the AC contactor to trigger a preconditioning event when the fast charge contactor is open and the AC contactor is closed; close the fast charge contactor to enable the DC charging of the power storage device when the AC contactor is open; open the fast charge contactor to enable the AC charging of the power storage device when the AC contactor is closed; and prevent triggering of the preconditioning event when the anomaly in the fast charge contactor is detected and the external power source connected to the charge port is an AC power source. An example is provided with respect to FIG. 2D.
(B1) In another aspect, some implementations include a charging method (e.g., the method 400, shown in FIG. 4) for an electric vehicle. The method includes receiving, by a charge port connected to an electric vehicle supply equipment (EVSE), supplying electric power from an external power source; and supplying, by a fast charge contactor that is connected in a Direct Current (DC) path between the charge port and a battery contactor connected to terminals of a power storage device of the electric vehicle, the electric power to the battery contactor to allow DC charging of the power storage device. The method further includes connecting an on-board charger positioned in an Alternating Current (AC) path between the charge port and the battery contactor to allow AC charging of the power storage device; controlling, by a PathSet Contactor, the supply of the electric power from the charge port to the battery contactor and switch between the DC charging and the AC charging of the power storage device; and controlling, by a controller, switching of at least the PathSet Contactor and the fast charge contactor to control charging of the power storage device. Examples are provided above with respect to FIGS. 2A-2D.
(B2) The method of B1, where controlling, by the PathSet Contactor, further includes controlling supplying of the electric power between the DC path and the AC path based on detection of an anomaly in the fast charge contactor.
(C1) In another aspect, some implementations include charging system (e.g., charging system 200, shown in FIGS. 2A-2D) for an electric vehicle. The method includes a charge port connected to an electric vehicle supply equipment and configured to receive electrical power from the electric vehicle supply equipment; a battery contactor connected to terminals of a power storage device of the electric vehicle; a fast charge contactor connected in a Direct Current (DC) path between the charge port and the battery contactor to enable DC charging of the power storage device; an on-board charger connected in an Alternating Current path (AC) between the charge port and the battery contactor, wherein the on-board charger is configured to enable AC charging of the power storage device; a PathSet Contactor configured to control supplying electrical power from the charge port to the battery contactor and switch between the DC charging and the AC charging of the power storage device; and a controller configured to control switching of at least the PathSet Contactor and the fast charge contactor to control charging of the power storage device.
(C2) The charging system of C1, where the PathSet Contactor is configured to control supplying electrical power, selecting between either the DC path or the AC path based on detection of an anomaly in the fast charge contactor.
(C3) The charging system of any of C1 and C2, where the PathSet Contactor is configured to control supplying electrical power, selecting between either the DC path or the AC path based on detection that one or more contacts of the fast charge contactor are in a welded state.
(C4) The charging system of any of C1-C3, where the PathSet Contactor includes a plurality of switches positioned in the DC path between the charge port and the fast charge contactor. The PathSet Contactor is configured to switch between unidirectional paths generated by a plurality of diodes to selectively control supplying electrical power to the power storage device in the DC path, thereby controlling supplying of electric energy of the power storage device to a secondary power storage device. The controller is configured to open the PathSet contactor when an anomaly in the fast charge contactor is detected and the charge port is receiving AC power. Examples are provided with respect to FIGS. 2A and 2B.
(C5) The charging system of any of C1-C4, where the controller is configured to: close the PathSet Contactor when an operating voltage of the power storage device is higher than a peak voltage in the AC path; and open the PathSet Contactor when the operating voltage of the power storage device is lower than or equal to the peak voltage in the AC path.
(C6) The charging system of any of C1-C5, where the PathSet Contactor includes a 4Quadrant switch positioned in the DC path between the charge port and the fast charge contactor. The PathSet Contactor is configured to selectively control supplying the electrical power to the power storage device in the DC path and control supplying electrical power stored in the power storage device to a secondary power storage device. The controller is configured to open the 4Quadrant switch when an anomaly is detected in the fast charge contactor and the charge port is receiving AC power. An example is provided with respect to FIG. 2B.
(C7) The charging system of any of C1-C6, where the PathSet Contactor is an AC/DC switch configured to switch supplying the electrical power from the charge port, selecting between the DC path and the AC path to enable selective switching between DC charging and AC charging of the power storage device.
(C8) The charging system of any of C1-C7, further including a diode positioned downstream of the on-board charger in the AC path. The controller is configured to: close the fast charge contactor to enable DC charging of the power storage device when the AC/DC switch is connected to the DC path and the diode is in reverse bias; open the fast charge contactor to enable AC charging of the power storage device when the AC/DC switch is connected to the AC path and the diode is in forward bias; and open the AC/DC switch when an anomaly is detected in the fast charge contactor or an anomaly is detected in the diode and the charge port is receiving AC power. An example is provided with respect to FIG. 2C.
(C9) The charging system of any of C1-C8, where the PathSet Contactor is an AC contactor positioned downstream of the on-board charger in the AC path, and the PathSet Contactor operates inversely with the fast charge contactor. The controller is configured to: determine operating states of the fast charge contactor and the AC contactor to trigger a preconditioning event when the fast charge contactor is open and the AC contactor is closed; close the fast charge contactor to enable DC charging of the power storage device when the AC contactor is open; open the fast charge contactor to enable AC charging of the power storage device when the AC contactor is closed; and prevent triggering of the preconditioning event when an anomaly in the fast charge contactor is detected and the charge port is receiving AC power. An example is provided with respect to FIG. 2D.
(D1) In another aspect, some implementations include a charging method (e.g., the method 500) for charging an electric vehicle. The method includes receiving electrical power at a charge port; determining whether the electrical power is Direct Current (DC) power or Alternating Current (AC) power; and controlling, by a controller, switching of at least a fast charge contactor and a PathSet contactor to enable selectively transmitting the electrical power from the charge port to a power storage device via a DC path or an AC path. The fast charge contactor is connected in a DC path between the charge port and a battery contactor and the battery contactor is connected to terminals of the power storage device of the electric vehicle. The PathSet contactor is configured to control the supply of the electric power from the charge port to the battery contactor and switch between DC charging of the power storage device via the DC path and AC charging of the power storage device via the AC path.
(D2) The method of D1, further including detecting an anomaly in the fast charge contactor and in response to detecting the anomaly in the fast charge contactor, controlling, by the controller, switching of at least the fast charge contactor and the PathSet contactor to direct the electrical power between utilizing the DC path or utilizing the AC path.
(D3) The method of any of D1 and D2, where the PathSet Contactor includes a plurality of switches positioned in the DC path between the charge port and the fast charge contactor. The method further includes, in response to a determination that the electrical power received at the charge port is DC power, switching one or more switches of the plurality of switches to a closed state and switching the fast charge contactor to a closed state to enable charging of the power storage device via the DC path. The method also includes, in response to a determination that the electrical power received at the charge port is AC power, switching one or more switches of the plurality of switches to an open state and switching the fast charge contactor to an open state to enable charging of the power storage device via the DC path.
(D4) The method of D3, further including determining an operating voltage of the power storage device and a peak voltage in the AC path. The method further includes, in response to (i) a determination that the electrical power received at the charge port is AC power, (ii) detection of an anomaly, and (iii) a determination that the operating voltage of the power storage device is higher than the peak voltage in the AC path: switching one or more switches of the plurality of switches to a closed state. The method also includes, in response to (i) a determination that the electrical power received at the charge port is AC power, (ii) detection of an anomaly, and (iii) a determination that the operating voltage of the power storage device is lower than or equal to the peak voltage in the AC path: switching one or more switches of the plurality of switches to an open state.
(D6) The method of any of D1 and D2, where the PathSet Contactor includes a 4Quadrant switch positioned in the DC path between the charge port and the fast charge contactor. The method further includes, in response to a determination that the electrical power received at the charge port is DC power, switching the 4Quadrant switch to a closed state and switching the fast charge contactor to a closed state to selectively control supplying the electrical power to the power storage device in the DC path. The method also includes, in response to a determination that the electrical power received at the charge port is AC power, switching the 4Quadrant switch to a closed state and switching the fast charge contactor to an open state and switch the fast charge contactor to an open state to selectively control supplying the electrical power to the power storage device in the DC path
(D7) The method of D6, further including determining an operating voltage of the power storage device and a peak voltage in the AC path. The method also includes, in response to (i) a determination that the electrical power received at the charge port is AC power, (ii) detection of an anomaly, and (iii) a determination that the operating voltage of the power storage device is higher than the peak voltage in the AC path: switching the 4Quadrant switch to a closed state and switching the fast charge contactor to a closed state to selectively control supplying the electrical power to the power storage device in the DC path. The method further includes, in response to (i) a determination that the electrical power received at the charge port is AC power, (ii) detection of an anomaly, and (iii) a determination that the operating voltage of the power storage device is lower than or equal to the peak voltage in the AC path: switching the 4Quadrant switch to an open state and switching the fast charge contactor to an open state to selectively control supplying the electrical power to the power storage device in the DC path.
(D8) The method of any of D1 and D2, where the PathSet Contactor includes an AC/DC switch connected to the AC path and the AC path includes a diode. The method further includes, in response to a determination that the electrical power received at the charge port is DC power and in response to a determination that the diode is connected in the AC path is in reverse bias, connecting the AC/DC switch to the DC path and switching the fast charge contactor to a closed state to enable DC charging of the power storage device via the DC path. The method also includes, in response to a determination that the electrical power received at the charge port is AC power and in response to a determination that the diode is connected in the AC path is in forward bias, connecting the AC/DC switch to the AC path and switching the fast charge contactor to an open state to enable AC charging of the power storage device via the AC path.
(D9) The method of D8, further including, in response to a determination that the electrical power received at the charge port is AC power and in response to detecting the anomaly in the fast charge contactor, connecting the AC/DC switch to the AC path.
(D10) The method of any of D1 and D2, where the PathSet Contactor includes an AC contactor that is positioned in the AC path, and the AC contactor operates inversely with the fast charge contactor. The method further includes determining, by the controller, operating states of the fast charge contactor and the AC contactor. The method also includes, in response to a determination that the electrical power received at the charge port is DC power and in response to a determination that the AC contactor is open, switching the fast charge contactor to a closed state to enable DC charging of the power storage device. The method further includes, in response to a determination that the electrical power received at the charge port is AC power and in response to a determination that the AC contactor is closed, switching the fast charge contactor to an open state to enable AC charging of the power storage device. The method also includes, in response to a determination that the fast charge contactor is open and the AC contactor is closed, triggering, by the controller, a preconditioning event signal.
(D10) The method of D10, further including, in response to a determination that the electrical power received at the charge port is AC power and in response to detecting the anomaly in the fast charge contactor, switching one or more of the AC contactor and the fast charge contactor to prevent triggering the preconditioning event signal.
(D10) The method of any of D1-D7, further including controlling, by the controller, switching of at least one of the fast charge contactor and the PathSet contactor to enable supplying electrical power stored in the power storage device to a secondary power storage device.
(E1) In one aspect, some implementations include a charging system (e.g., charging system 200, shown in FIGS. 2A-2D), for an electric vehicle include: a charge port that is connected to an electric vehicle supply equipment (EVSE) and configured to receive electric power from electric vehicle supply equipment; a battery contactor connected to terminals of a power storage device of the electric vehicle; a fast charge contactor connected in a Direct Current (DC) path between the charge port and the battery contactor to enable DC charging of the power storage device; an on-board charger connected in an Alternating Current (AC) path between the charge port (and the battery contactor, and configured to enable AC charging of the power storage device; a PathSet Contactor configured to control supplying the electric power from the charge port to the battery contactor and switch between the DC charging and the AC charging of the power storage device; and a controller configured to control switching of at least the PathSet Contactor and the fast charge contactor to control charging of the power storage device.
(E2) The charging system of E1, where the PathSet Contactor is configured to control the supply of the electric power between the DC path and the AC path based on detection of an anomaly in the fast charge contactor.
(E3) The charging system of E1 or E2, where the PathSet Contactor includes a plurality of switches positioned in the DC path between the charge port and the fast charge contactor. The PathSet Contactor is configured to switch between unidirectional paths generated by a plurality of diodes (D1, D2) to selectively control the supply of the electric power to the power storage device in the DC path, and to control the supply of electric energy of the power storage device to a secondary power storage device. The controller is configured to open the PathSet contactor when an anomaly in the fast charge contactor is detected and the charge port is receiving AC power. An example is provided with respect to FIG. 2A.
(E4) The charging system of any of E1-E3, where the controller is configured to: close the PathSet Contactor when an operating voltage of the power storage device is higher that a peak voltage in the AC path and open the PathSet Contactor when the operating voltage of the power storage device is lower than the peak voltage in the AC path.
(E5) The charging system of any of E1-E4, where the PathSet Contactor is a 4Quadrant switch positioned in the DC path between the charge port and the fast charge contactor to selectively control the supply of the electric power to the power storage device in the DC path, and control the supply of the electric energy of the power storage device to a secondary power storage device. The controller is configured to operate the 4Quadrant switch as open when the anomaly in the fast charge contactor is detected and the charge port is receiving AC power. An example is provided with respect to FIG. 2B.
(E6) The charging system of any of E1-E5, where the PathSet Contactor is an AC/DC switch configured to switch the supply of the electric power from the charge port between the DC path and the AC path to enable selective switching between the DC charging and the AC charging of the power storage device.
(E7) The charging system of any of E1-E6, further including a diode positioned downstream of the on-board charger in the AC path. The controller is configured to: close the fast charge contactor to enable the DC charging of the power storage device when the AC/DC switch is connected to the DC path and the diode is in reverse bias; open the fast charge contactor to enable the AC charging of the power storage device when the AC/DC switch is connected to the AC path and the diode is in forward bias; and open the AC/DC switch when the anomaly in the fast charge contactor is detected or an anomaly is detected in the diode and the charge port is receiving AC power. An example is provided with respect to FIG. 2C.
(E8) The charging system of any of E1-E7, where the PathSet Contactor is an AC contactor positioned downstream of the on-board charger in the AC path and operating complementary with the fast charge contactor. The controller is configured to: determine operating states of the fast charge contactor and the AC contactor to trigger a preconditioning event when the fast charge contactor is open and the AC contactor is closed; close the fast charge contactor to enable the DC charging of the power storage device when the AC contactor is open; open the fast charge contactor to enable the AC charging of the power storage device when the AC contactor is closed; and prevent triggering of the preconditioning event when the anomaly in the fast charge contactor is detected and the charge port is receiving AC power. An example is provided with respect to FIG. 2D.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a charging system and method for improving reliability of charging process of power storage devices installed in an electric vehicle, while minimizing the redundancy of the charging system.

The present disclosure provides a cost-effective solution that is based on a charging topology for facilitating charging of the power storage device using both AC charging stations and DC charging stations using a single charge port.

The present disclosure provides a charging system and method that ensures safety of power storage device installed in the electric vehicle as well as safety of the AC charging stations or the DC charging stations.

The present disclosure provides a simple and reliable charging system for efficiently preventing faults or abnormalities in the charging system to safeguard the power storage device mounted in the electric vehicle. A method for charging the power storage device mounted in the electric vehicle using the charging system described herein is also disclosed.

The present disclosure provides charging system for an electric vehicle that utilizes a same charging port to receive both AC power and DC power for charging. The charging system of the present disclosure includes components and methods for accurately determining whether AC power or DC power is being supplied to the system, and controls to properly direct AC power or DC power via an appropriate electrical path (e.g., an AC path or a DC path) for charging. The charging system of the present disclosure also includes components and methods for safely delivering AC power or DC power to a power storage device of the electric vehicle even in the presence of an anomaly or component malfunction.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A charging system for an electric vehicle, comprising:
a charge port connected to an electric vehicle supply equipment and configured to receive electrical power from the electric vehicle supply equipment;
a battery contactor connected to terminals of a power storage device of the electric vehicle;
a fast charge contactor connected in a Direct Current (DC) path between the charge port and the battery contactor to enable DC charging of the power storage device;
an on-board charger connected in an Alternating Current (AC) path between the charge port and the battery contactor, wherein the on-board charger is configured to enable AC charging of the power storage device;
a PathSet Contactor configured to control supplying electrical power from the charge port to the battery contactor and switch between the DC charging and the AC charging of the power storage device; and
a controller configured to control switching of at least the PathSet Contactor and the fast charge contactor to control charging of the power storage device.

2. The charging system of claim 1, wherein the PathSet Contactor is configured to control supplying electrical power, selecting between either the DC path or the AC path based on detection of an anomaly in the fast charge contactor.

3. The charging system of claim 1, wherein the PathSet Contactor is configured to control supplying electrical power, selecting between either the DC path or the AC path based on detection that one or more contacts of the fast charge contactor are in a welded state.

4. The charging system of claim 1, wherein:
the PathSet Contactor comprises a plurality of switches positioned in the DC path between the charge port and the fast charge contactor;
the PathSet Contactor is configured to switch between unidirectional paths generated by a plurality of diodes to selectively control supplying electrical power to the power storage device in the DC path, thereby controlling supplying of electric energy of the power storage device to a secondary power storage device; and
the controller is configured to open the PathSet contactor when an anomaly in the fast charge contactor is detected and the charge port is receiving AC power.

5. The charging system of claim 1, wherein the controller is configured to:
close the PathSet Contactor when an operating voltage of the power storage device is higher than a peak voltage in the AC path; and
open the PathSet Contactor when the operating voltage of the power storage device is lower than or equal to the peak voltage in the AC path.

6. The charging system of claim 1, wherein:
the PathSet Contactor includes a 4Quadrant switch positioned in the DC path between the charge port and the fast charge contactor;
the PathSet Contactor is configured to selectively control supplying the electrical power to the power storage device in the DC path and control supplying electrical power stored in the power storage device to a secondary power storage device; and
the controller is configured to open the 4Quadrant switch when an anomaly is detected in the fast charge contactor and the charge port is receiving AC power.

7. The charging system of claim 1, wherein the PathSet Contactor includes an AC/DC switch configured to switch supplying the electrical power from the charge port, selecting between the DC path and the AC path to enable selective switching between DC charging and AC charging of the power storage device.

8. The charging system of claim 7, further comprising:
a diode positioned downstream of the on-board charger in the AC path, wherein the controller is configured to:
close the fast charge contactor to enable DC charging of the power storage device when the AC/DC switch is connected to the DC path and the diode is in reverse bias;
open the fast charge contactor to enable AC charging of the power storage device when the AC/DC switch is connected to the AC path and the diode is in forward bias; and
open the AC/DC switch when an anomaly is detected in the fast charge contactor or an anomaly is detected in the diode and the charge port is receiving AC power.

9. The charging system of claim 1, wherein:
the PathSet Contactor includes an AC contactor positioned downstream of the on-board charger in the AC path, and the PathSet Contactor operates inversely with the fast charge contactor; and
the controller is configured to:
determine operating states of the fast charge contactor and the AC contactor to trigger a preconditioning event when the fast charge contactor is open and the AC contactor is closed;
close the fast charge contactor to enable DC charging of the power storage device when the AC contactor is open;
open the fast charge contactor to enable AC charging of the power storage device when the AC contactor is closed; and
prevent triggering of the preconditioning event when an anomaly in the fast charge contactor is detected and the charge port is receiving AC power.

10. A charging method for an electric vehicle, comprising:
receiving electrical power at a charge port;
determining whether the electrical power is Direct Current (DC) power or Alternating Current (AC) power; and
controlling, by a controller, switching of at least a fast charge contactor and a PathSet contactor to enable selectively transmitting the electrical power from the charge port to a power storage device via a DC path or an AC path, wherein:
the fast charge contactor is connected in a DC path between the charge port and a battery contactor;
the battery contactor is connected to terminals of the power storage device of the electric vehicle; and
the PathSet contactor is configured to control supplying of the electric power from the charge port to the battery contactor and switch between DC charging of the power storage device via the DC path and AC charging of the power storage device via the AC path.

11. The charging method of claim 10, further comprising:
detecting an anomaly in the fast charge contactor; and
in response to detecting the anomaly in the fast charge contactor, controlling, by the controller, switching of at least the fast charge contactor and the PathSet contactor to direct the electrical power between utilizing the DC path or utilizing the AC path.

12. The charging method of claim 11, wherein the PathSet Contactor includes a plurality of switches positioned in the DC path between the charge port and the fast charge contactor, the method further comprising:
in response to a determination that the electrical power received at the charge port is DC power, switching one or more switches of the plurality of switches to a closed state and switching the fast charge contactor to a closed state to enable charging of the power storage device via the DC path; and
in response to a determination that the electrical power received at the charge port is AC power, switching one or more switches of the plurality of switches to an open state and switching the fast charge contactor to an open state to enable charging of the power storage device via the DC path.

13. The charging method of claim 12, further comprising:
determining an operating voltage of the power storage device and a peak voltage in the AC path;
in response to (i) a determination that the electrical power received at the charge port is AC power, (ii) detection of an anomaly, and (iii) a determination that the operating voltage of the power storage device is higher than the peak voltage in the AC path:
switching one or more switches of the plurality of switches to a closed state; and
in response to (i) a determination that the electrical power received at the charge port is AC power, (ii) detection of an anomaly, and (iii) a determination that the operating voltage of the power storage device is lower than or equal to the peak voltage in the AC path:
switching one or more switches of the plurality of switches to an open state.

14. The charging method of claim 11, wherein the PathSet Contactor includes a 4Quadrant switch positioned in the DC path between the charge port and the fast charge contactor, the method further comprising:
in response to a determination that the electrical power received at the charge port is DC power, switching the 4Quadrant switch to a closed state and switching the fast charge contactor to a closed state to selectively control supplying the electrical power to the power storage device in the DC path; and
in response to a determination that the electrical power received at the charge port is AC power, switching the 4Quadrant switch to a closed state and switching the fast charge contactor to an open state and switch the fast charge contactor to an open state to selectively control supplying the electrical power to the power storage device in the DC path.

15. The charging method of claim 14, further comprising:
determining an operating voltage of the power storage device and a peak voltage in the AC path;
in response to (i) a determination that the electrical power received at the charge port is AC power, (ii) detection of an anomaly, and (iii) a determination that the operating voltage of the power storage device is higher than the peak voltage in the AC path:
switching the 4Quadrant switch to a closed state and switching the fast charge contactor to a closed state to selectively control supplying the electrical power to the power storage device in the DC path; and
in response to (i) a determination that the electrical power received at the charge port is AC power, (ii) detection of an anomaly, and (iii) a determination that the operating voltage of the power storage device is lower than or equal to the peak voltage in the AC path:
switching the 4Quadrant switch to an open state and switching the fast charge contactor to an open state to selectively control supplying the electrical power to the power storage device in the DC path.

16. The charging method of claim 11, wherein the PathSet Contactor includes an AC/DC switch connected to the AC path and the AC path includes a diode, the method further comprising:
in response to a determination that the electrical power received at the charge port is DC power and in response to a determination that the diode is connected in the AC path is in reverse bias, connecting the AC/DC switch to the DC path and switching the fast charge contactor to a closed state to enable DC charging of the power storage device via the DC path; and
in response to a determination that the electrical power received at the charge port is AC power and in response to a determination that the diode is connected in the AC path is in forward bias, connecting the AC/DC switch to the AC path and switching the fast charge contactor to an open state to enable AC charging of the power storage device via the AC path.

17. The charging method of claim 16, further comprising:
in response to a determination that the electrical power received at the charge port is AC power and in response to detecting the anomaly in the fast charge contactor, connecting the AC/DC switch to the AC path.

18. The charging method of claim 11, wherein the PathSet Contactor includes an AC contactor positioned in the AC path and the AC contactor operates inversely with the fast charge contactor, the method further comprising:
determining, by the controller, operating states of the fast charge contactor and the AC contactor;
in response to a determination that the electrical power received at the charge port is DC power and in response to a determination that the AC contactor is open, switching the fast charge contactor to a closed state to enable DC charging of the power storage device;
in response to a determination that the electrical power received at the charge port is AC power and in response to a determination that the AC contactor is closed, switching the fast charge contactor to an open state to enable AC charging of the power storage device; and
in response to a determination that the fast charge contactor is open and the AC contactor is closed, triggering, by the controller, a preconditioning event signal.

19. The charging method of claim 18, further comprising:
in response to a determination that the electrical power received at the charge port is AC power and in response to detecting the anomaly in the fast charge contactor, switching one or more of the AC contactor and the fast charge contactor to prevent triggering the preconditioning event signal.

20. The charging method of claim 10, further comprising:
controlling, by the controller, switching of at least one of the fast charge contactor and the PathSet contactor to enable supplying electrical power stored in the power storage device to a secondary power storage device.
